(19) United States
(12) Patent Application Publication
(10) Pub. No.: US 2025/0336591 A1
(43) Pub. Date: Oct. 30, 2025

(54) INDUCTOR COMPONENT

(71) Applicant: Murata Manufacturing Co., Ltd., Kyoto-fu (JP)

(72) Inventors: Yoshimasa YOSHIOKA, Nagaokakyo-shi (JP); Yuuki KAWAKAMI, Nagaokakyo-shi (JP); Keisuke KUNIMORI, Nagaokakyo-shi (JP); Kenji TOYOSHIMA, Nagaokakyo-shi (JP)

(73) Assignee: Murata Manufacturing Co., Ltd., Kyoto-fu (JP)

(21) Appl. No.: 19/188,711

(22) Filed: Apr. 24, 2025

(30) Foreign Application Priority Data
Apr. 25, 2024 (JP) 2024-071770

(51) Int. Cl. H01F 27/28; H01F 27/29; H01F 27/32

(52) U.S. Cl. CPC H01F 27/2828; H01F 27/292; H01F 27/324

(57) ABSTRACT

An inductor component includes a first conductor layer on a first virtual plane, a first inductor wiring that is on the first conductor layer and extends around a first turning axis along a first direction intersecting with the first virtual plane, and a first interlayer insulating layer that is in contact with the first conductor layer and is on a side opposite to the first inductor wiring with respect to the first conductor layer in the first direction. The first conductor layer includes a first main body portion that extends around the first turning axis, and a first protruding portion that extends from the first main body portion in a direction approaching the first turning axis and does not extend in a shortest distance from a connection portion with the main body portion toward an end portion of the first interlayer insulating layer when viewed along the first direction.

### CROSS-REFERENCE TO RELATED APPLICATION

This application claims benefit of priority to Japanese Patent Application No. 2024-071770, filed Apr. 25, 2024, the entire content of which is incorporated herein by reference.

### BACKGROUND

### Technical Field

The present disclosure relates to an inductor component.

### Background Art

Japanese Unexamined Patent Application Publication No. 2016-103591 discloses a coil component including a substrate and a coil provided on a main surface of the substrate by plating growth. In the coil component of Japanese Unexamined Patent Application Publication No. 2016-103591, a seed pattern for growing the coil via plating is formed on the substrate. The seed pattern includes a spiral pattern and a conductive pattern extending from the spiral pattern toward the outside of the substrate.

### SUMMARY

In the coil component of Japanese Unexamined Patent Application Publication No. 2016-103591, the conductive pattern extends straight in a direction orthogonal to a side surface of the substrate, and thus a wiring may be eroded and dissolved by an etching solution during manufacturing. In a case in which the wiring is dissolved during manufacturing, there is a concern that the direct current resistance of the coil component be varied or the direct current resistance is increased.

Accordingly, the present disclosure provides an inductor component capable of suppressing a variation and an increase in the direct current resistance.

An aspect of the present disclosure provides an inductor component including a first conductor layer that is located on a first virtual plane; a first inductor wiring that is provided on the first conductor layer and that extends around a first turning axis along a first direction intersecting with the first virtual plane; and a first interlayer insulating layer that is in contact with the first conductor layer and that is located on a side opposite to the first inductor wiring with respect to the first conductor layer in the first direction. The first conductor layer includes a first main body portion that extends around the first turning axis, and a first protruding portion that extends from the first main body portion in a direction approaching the first turning axis. The first protruding portion does not extend in a shortest distance from a connection portion with the main body portion toward an end portion of the first interlayer insulating layer when viewed along the first direction.

With the inductor component according to the above-described aspect, it is possible to suppress the variation and the increase in the direct current resistance.

### BRIEF DESCRIPTION OF THE DRAWINGS

FIG. 1 is a plan view illustrating an inductor component according to an aspect of the present disclosure;

FIG. 2 is a cross-sectional view taken along a line II-II of FIG. 1;

FIG. 3 is a schematic plan view illustrating layers of a first inductor wiring and a third inductor wiring of the inductor component of FIG. 1;

FIG. 4 is a schematic plan view illustrating layers of a second inductor wiring and a fourth inductor wiring of the inductor component of FIG. 1;

FIG. 5 is a first view illustrating an example of a manufacturing method for the inductor component of FIG. 1;

FIG. 6 is a second view illustrating the example of the manufacturing method for the inductor component of FIG. 1;

FIG. 7 is a third view illustrating the example of the manufacturing method for the inductor component of FIG. 1;

FIG. 8 is a fourth view illustrating the example of the manufacturing method for the inductor component of FIG. 1;

FIG. 9 is a fifth view illustrating the example of the manufacturing method for the inductor component of FIG. 1;

FIG. 10 is a sixth view illustrating the example of the manufacturing method for the inductor component of FIG. 1;

FIG. 11 is a seventh view illustrating the example of the manufacturing method for the inductor component of FIG. 1;

FIG. 12 is an eighth view illustrating the example of the manufacturing method for the inductor component of FIG. 1;

FIG. 13 is a ninth view illustrating the example of the manufacturing method for the inductor component of FIG. 1;

FIG. 14 is a tenth view illustrating the example of the manufacturing method for the inductor component of FIG. 1;

FIG. 15 is a perspective view illustrating a first modification example of the inductor component of FIG. 1;

FIG. 16 is an enlarged side view illustrating a second modification example of the inductor component of FIG. 1;

FIG. 17 is a schematic plan view illustrating a third modification example of the inductor component of FIG. 1; and

FIG. 18 is a schematic plan view illustrating a fourth modification example of the inductor component of FIG. 1.

### DETAILED DESCRIPTION

Various aspects of the present disclosure will be described.

A first aspect provides an inductor component including a first conductor layer that is located on a first virtual plane; a first inductor wiring that is provided on the first conductor layer and that extends around a first turning axis along a first direction intersecting with the first virtual plane; and a first interlayer insulating layer that is in contact with the first conductor layer and that is located on a side opposite to the first inductor wiring with respect to the first conductor layer in the first direction. The first conductor layer includes a first main body portion that extends around the first turning axis, and a first protruding portion that extends from the first main body portion in a direction approaching the first turning axis. The first protruding portion does not extend in a shortest distance from a connection portion with the main body portion toward an end portion of the first interlayer insulating layer when viewed along the first direction.

A second aspect provides the inductor component according to the first aspect, further including: an element body that includes a magnetic material and in which the first conductor layer and the first inductor wiring are located, in which the element body has, inside, a first region closer to the first turning axis than the first inductor wiring and a second region farther from the first turning axis than the first inductor wiring, and the magnetic material is located in the first region and the second region.

A third aspect provides the inductor component according to the second aspect, further including: a first insulating layer that is located inside the element body and that is in contact with a side surface of the first inductor wiring intersecting with a second direction intersecting with the first direction, in which an end portion, which is closer to the first inductor wiring, among both ends of the first protruding portion in the first direction is in contact with the first insulating layer, and an end, which is farther from the first main body portion, among both ends of the first protruding portion in a direction in which the first protruding portion extends is in contact with the magnetic material.

A fourth aspect provides the inductor component according to any one of the first to third aspects, in which the first conductor layer has a thickness that is a dimension in the first direction of smaller than 1.0 μm, and the thickness of the first conductor layer is smaller than 1/100 of the thickness of the first inductor wiring.

A fifth aspect provides the inductor component according to any one of the first to fourth aspects, further including a second conductor layer that is provided on a second virtual plane parallel and adjacent to the first virtual plane; a second inductor wiring that is provided on the second conductor layer, that is located between the first conductor layer and the second conductor layer, and that extends around a second turning axis along the first direction; and a second interlayer insulating layer that is in contact with the second conductor layer and that is located on a side opposite to the second inductor wiring with respect to the second conductor layer in the first direction. The second conductor layer includes a second main body portion that extends around the second turning axis, and a second protruding portion that extends from the second main body portion in a direction approaching the second turning axis. The second protruding portion does not extend in a shortest distance from a connection portion with the second main body portion toward an end portion of the second interlayer insulating layer when viewed along the first direction. The first inductor wiring includes a first input portion that is connected to a first input element and a first output portion that is connected to an output element. The second inductor wiring includes a second input portion that is connected to a second input element different from the first input element and a second output portion that is connected to the output element, and when viewed along the first direction. The first input portion and the second input portion are located at positions separated from each other in a second direction intersecting with the first direction, and the first output portion and the second output portion are adjacent to each other.

A sixth aspect provides the inductor component according to any one of the first to fourth aspects, in which the first conductor layer includes a lead-out portion that extends from the first main body portion in a direction separated from the first turning axis in a second direction intersecting with the first direction or in a direction approaching the first turning axis in the second direction. In a case in which, when viewed along the first direction, a size of the lead-out portion in a direction intersecting with a direction in which the lead-out portion extends is defined as a width of the lead-out portion, and a size of the first inductor wiring in a direction intersecting with a direction in which the first inductor wiring extends is defined as a width of the first inductor wiring, the width of the lead-out portion is larger than the width of the first inductor wiring.

A seventh aspect provides the inductor component according to the second aspect, further including an external terminal that is provided on an outer surface of the element body intersecting with the first direction; and a vertical wiring that is located inside the element body, in which when viewed along the first direction, the vertical wiring is provided at a position not overlapping with the first region and the second region, is in contact with the magnetic material of the element body in a second direction intersecting with the first direction, and extends in the first direction to connect the first inductor wiring and the external terminal to each other.

An eighth aspect provides the inductor component according to any one of the first to fourth aspects, in which the first conductor layer includes a lead-out portion that extends from the first main body portion in a direction approaching the first turning axis in a second direction intersecting with the first direction, and the lead-out portion is provided in a portion of the first main body portion that faces the first turning axis in the second direction and that is farthest from the first turning axis.

A ninth aspect provides the inductor component according to any one of the first to eighth aspects, further including a second conductor layer that is provided on a second virtual plane parallel and adjacent to the first virtual plane; a second inductor wiring that is provided on the second conductor layer, that is located between the first conductor layer and the second conductor layer, and that extends around a second turning axis along the first direction; and a second interlayer insulating layer that is in contact with the second conductor layer and that is located on a side opposite to the second inductor wiring with respect to the second conductor layer in the first direction. The second conductor layer includes a second main body portion that is located around the second turning axis, and a second protruding portion that extends from the second main body portion in a direction approaching the second turning axis. The second protruding portion does not extend in a shortest distance from a connection portion with the second main body portion toward an end portion of the second interlayer insulating layer when viewed along the first direction. The first conductor layer includes a first lead-out portion that extends from the first main body portion in a direction separated from the first turning axis along a second direction intersecting with the first direction. The second conductor layer includes a second lead-out portion that extends from the second main body portion in a direction separated from the second turning axis along the second direction. The inductor component includes a second insulating layer that is in contact with an end portion, which is closer to the first inductor wiring, among both ends of the first lead-out portion in the first direction, and a third insulating layer that is in contact with an end portion, which is closer to the second inductor wiring, among both ends of the second lead-out portion in the first direction, and when viewed along the first direction. The first lead-out portion and the second lead-out portion are located at positions overlapping with each other, a size of the third insulating layer is the same as or smaller than a size of the second insulating layer, and the second insulating layer overlaps with an entire third insulating layer.

A tenth aspect provides the inductor component according to any one of the first to fourth aspects, further including an element body in which the first conductor layer and the first inductor wiring are located, in which the element body has a side surface intersecting with a second direction intersecting with the first direction. The first conductor layer includes a lead-out portion that extends from the first main body portion in a direction separated from the first turning axis in the second direction, and a distal end portion, which is farther from the first main body portion, among both ends of the lead-out portion in the second direction is exposed from the side surface and is in contact with at least one insulating layer.

An eleventh aspect provides the inductor component according to any one of the first to fourth aspects, in which the first conductor layer includes a lead-out portion that extends from the first main body portion in a direction separated from the first turning axis in a second direction intersecting with the first direction or in a direction approaching the first turning axis in the second direction, and the lead-out portion includes at least one cavity.

A twelfth aspect provides the inductor component according to any one of the first to eleventh aspects, further including an element body in which the first conductor layer and the first inductor wiring are located, in which the element body has a side surface intersecting with a second direction intersecting with the first direction. The first conductor layer includes a plurality of lead-out portions that are provided in a portion of the first main body portion extending parallel to the side surface, and each of the plurality of lead-out portions extends from the first main body portion in a direction separated from the first turning axis in the second direction or in a direction approaching the first turning axis in the second direction.

A thirteenth aspect provides the inductor component according to any one of the first to twelfth aspects, in which the first virtual straight line and a second virtual straight line extending in a direction in which the first inductor wiring extends form an angle other than a right angle when viewed along the first direction.

A fourteenth aspect provides the inductor component according to any one of the first to thirteenth aspects, further including a third conductor layer that is located on the first virtual plane; and a third inductor wiring that is provided on the third conductor layer and that extends around a third turning axis along the first direction. The first conductor layer includes a first lead-out portion that extends from the first main body portion in a direction separated from the first turning axis along a second direction intersecting with the first direction, the third conductor layer includes a third main body portion that is located around the third turning axis, and a second lead-out portion that extends from the third main body portion in a direction separated from the third turning axis along the second direction. The first conductor layer and the second conductor layer are located with spacing from each other in the second direction intersecting with the first direction. The first lead-out portion is provided in a portion of the first main body portion other than a portion facing the third conductor layer, and the third lead-out portion is provided in a portion of the third main body portion other than a portion facing the first conductor layer.

A fifteenth aspect provides an inductor component including a first conductor layer that is located on a first virtual plane; a first inductor wiring that is provided on the first conductor layer and that extends around a first turning axis along a first direction intersecting with the first virtual plane; and an element body that includes a magnetic material and in which the first conductor layer and the first inductor wiring are located. The element body has a side surface intersecting with a second direction intersecting with the first direction, and the first conductor layer includes a first main body portion that extends around the first turning axis, and a protruding portion that extends from the first main body portion in a direction separated from the first turning axis in a direction forming an angle with respect to a third virtual straight line orthogonal to the side surface.

Hereinafter, embodiments of the present disclosure will be described with reference to the drawings. The following description is not intended to limit the present disclosure, is merely an example, and can be appropriately changed without departing from the gist of the present disclosure. The drawings are schematic, and the ratios of the respective dimensions and the like do not necessarily match the actual values. In the following description, the terms “about”, “approximately”, “substantially”, and the like mean that the values, the shapes, and the like following these terms include a range of allowable errors decided on by those skilled in the art.

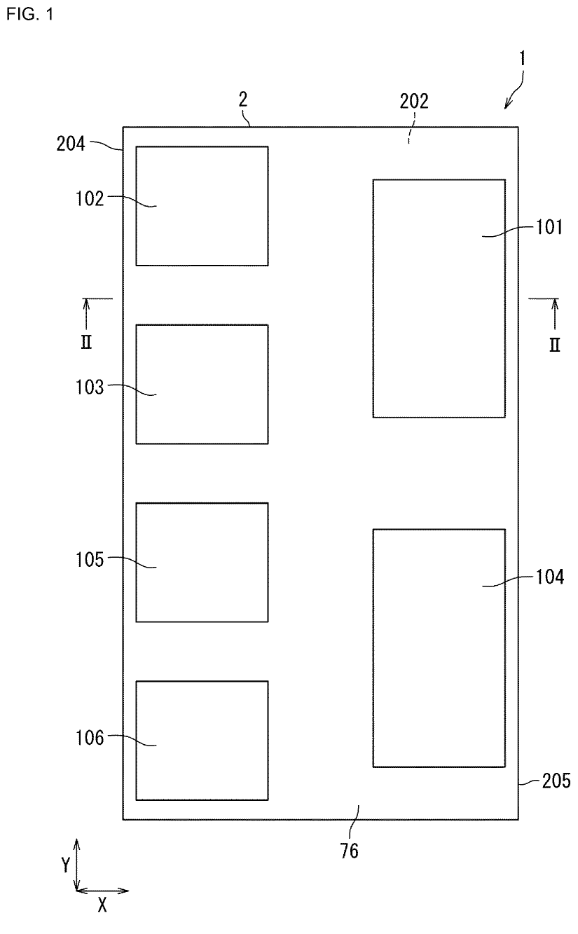

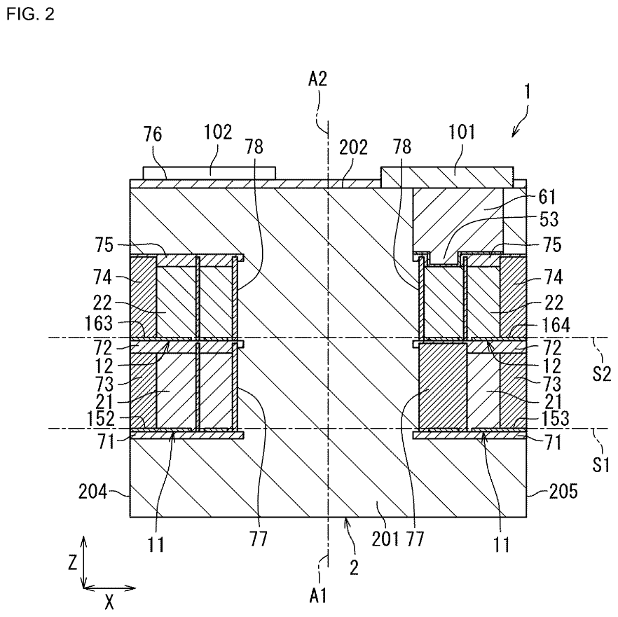

As illustrated in FIGS. 1 and 2, an inductor component 1 of the present disclosure includes a first conductor layer 11 and a first inductor wiring 21. The first conductor layer 11 extends (is located) to a first virtual plane S1. The first inductor wiring 21 is provided on the first conductor layer 11 and extends along the first virtual plane S1. The first inductor wiring 21 is located around a first turning axis A1 that intersects with (for example, that is orthogonal to) the first virtual plane S1. As an example, the first virtual plane S1 is located at a boundary between the first conductor layer 11 and the first inductor wiring 21.

In the present aspect, as illustrated in FIGS. 1 to 4, the inductor component 1 includes a substantially rectangular parallelepiped-shaped element body 2, a second conductor layer 12, a third conductor layer 13, a fourth conductor layer 14, a second inductor wiring 22, a third inductor wiring 23, and a fourth inductor wiring 24.

As illustrated in FIG. 2, the second conductor layer 12 extends (is located) on a second virtual plane S2 parallel and adjacent to the first virtual plane S1. The first inductor wiring 21 is located between the first conductor layer 11 and the second conductor layer 12 in a first direction (for example, a Z direction) intersecting with the first virtual plane S1 and the second virtual plane S2. Here, the second virtual plane S2 parallel and adjacent to the first virtual plane S1 means that the first virtual plane S1 and the second virtual plane S2 are parallel to each other, and the second virtual plane is present at a position separated in a direction orthogonal to the first virtual plane S1. The second inductor wiring 22 is provided on the second conductor layer 12 and extends along the second virtual plane S2. The second inductor wiring 22 includes the second conductor layer 12 that is located between the first inductor wiring 21 and the second inductor wiring 22 in the first direction Z, and is located around a second turning axis A2 that intersects with (for example, that is orthogonal to) the second virtual plane S2. As an example, the second virtual plane S2 is located at a boundary between the second conductor layer 12 and the second inductor wiring 22.

The element body 2 has, for example, a size of 1.2×2.1×0.55 mm. The third conductor layer 13 is located on the first virtual plane S1 and is electrically independent of the first conductor layer 11. The fourth conductor layer 14 is located on the second virtual plane S2 and is electrically independent of the second conductor layer 12. The third inductor wiring 23 is provided in the third conductor layer 13. The fourth inductor wiring 24 is provided in the fourth conductor layer 14. The third inductor wiring 23 extends along the first virtual plane S1. The fourth inductor wiring 24 extends along the second virtual plane S2. The layers of the first inductor wiring 21 and the third inductor wiring 23 are located between the first virtual plane S1 and the second virtual plane S2, and the layers of the second inductor wiring 22 and the fourth inductor wiring 24 are located between the second virtual plane S2 and a main surface 202 of the element body 2 described later.

The element body 2 includes a magnetic material (magnetic layer) 201, and the first conductor layer 11, the second conductor layer 12, the third conductor layer 13, the fourth conductor layer 14, the first inductor wiring 21, the second inductor wiring 22, the third inductor wiring 23, and the fourth inductor wiring 24 are located inside the element body 2. As illustrated in FIG. 2, the element body 2 has an outer surface (hereinafter, referred to as the main surface 202) intersecting with the first direction Z. As illustrated in FIG. 1, a plurality of external terminals (six external terminals 101 to 106 in the present aspect) and an insulating layer 76 are provided on the main surface 202. The insulating layer 76 has, for example, a thickness of 10 μm. In the present aspect, the second inductor wiring 22 is located closest to the main surface 202 (that is, the external terminal 101) in the first direction Z. Each of the external terminals 101 to 106 is formed of, for example, a multilayer body of Cu/Ni/Au (=5/5/0.1 um).

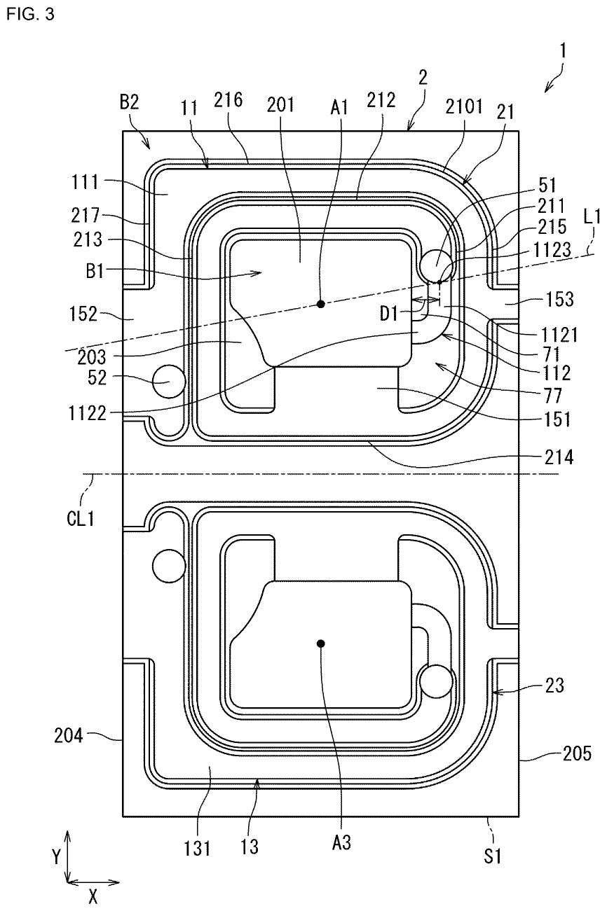

As illustrated in FIG. 3, when viewed along the first direction Z, the third conductor layer 13 is located symmetrically with respect to the first conductor layer 11 with a first center line CL1, which extends on the first virtual plane S1 in a lateral direction (for example, an X direction) of the inductor component 1, interposed therebetween, and has a shape symmetrical with respect to the first conductor layer 11 with the first center line CL1 interposed therebetween. The third inductor wiring 23 is located symmetrically with respect to the first inductor wiring 21 with the first center line CL1 interposed therebetween, and has a shape symmetrical with respect to the first inductor wiring 21 with the first center line CL1 interposed therebetween. The third inductor wiring 23 extends around a third turning axis A3 that is located symmetrically with respect to the first turning axis A1 with the first center line CL1 interposed therebetween.

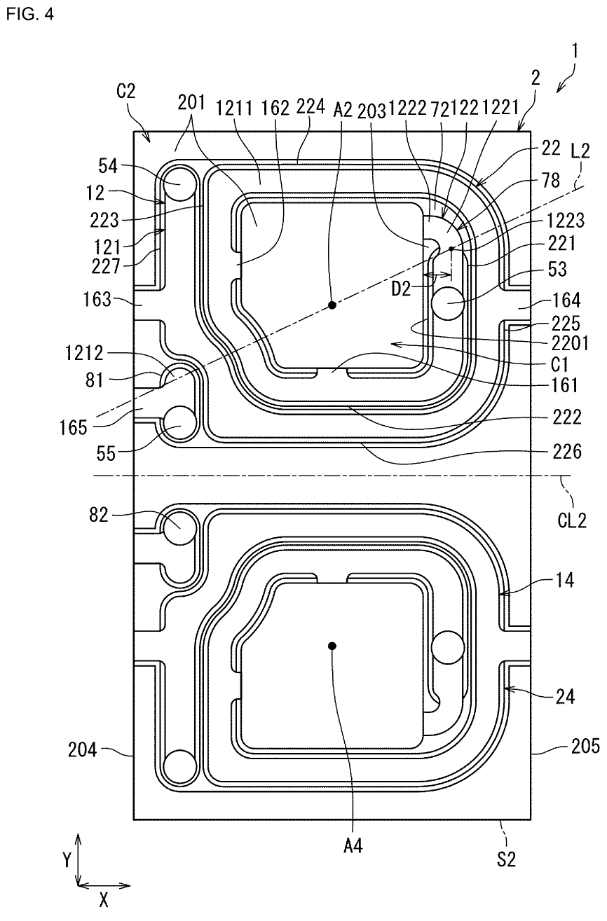

As illustrated in FIG. 4, when viewed along the first direction Z, the fourth conductor layer 14 is located symmetrically with respect to the second conductor layer 12 with a second center line CL2, which extends in the lateral direction X on the second virtual plane S2, interposed therebetween, and has a shape symmetrical with respect to the second conductor layer 12 with the second center line CL2 interposed therebetween. The fourth inductor wiring 24 is located symmetrically with respect to the second inductor wiring 22 with the second center line CL2 interposed therebetween, and has a shape symmetrical with respect to the second inductor wiring 22 with the second center line CL2 interposed therebetween. The fourth inductor wiring 24 extends around a fourth turning axis A4 that is located symmetrically with respect to the second turning axis A2 with the second center line CL2 interposed therebetween.

As an example, the first turning axis A1 and the second turning axis A2 are located on the same straight line (see FIG. 2), and the third turning axis A3 and the fourth turning axis A4 are located on the same straight line. The first center line CL1 and the second center line CL2 are located substantially at the center in a longitudinal direction (for example, a Y direction) of the inductor component 1 when viewed along the first direction Z.

As illustrated in FIG. 3, the first inductor wiring 21 has a spiral shape as an example when viewed along the first direction Z. As an example, the first turning axis A1 is located at the center with respect to an outer shape of the first inductor wiring 21. Vias 51 and 52 are connected to both ends of the first inductor wiring 21 in a direction in which the first inductor wiring 21 extends. The first inductor wiring 21 is formed of, for example, a multilayer body of L/S/t (=100/10/150 μm).

The first inductor wiring 21 includes a first portion 211 to a seventh portion 217.

The first portion 211 extends from an end portion located close to the first turning axis A1 to which the via 51 is connected, in a direction separated from the first center line CL1 along the longitudinal direction Y. As an example, a portion of the first portion 211 to which the via 51 is connected forms a first output portion.

The second portion 212 extends X from an end portion, which is farther from the first center line CL1, among both ends of the first portion 211 in the longitudinal direction Y, along the lateral direction.

The third portion 213 extends from an end portion, which is farther from the first portion 211, among both ends of the second portion 212 in the lateral direction X in a direction approaching the first center line CL1 along the longitudinal direction Y.

The fourth portion 214 extends from an end portion, which is farther from the second portion 212, among both ends of the third portion 213 in the longitudinal direction Y, in a direction approaching the first portion 211 along the lateral direction X.

The fifth portion 215 extends from an end portion, which is farther from the third portion 213, among both ends of the fourth portion 214 in the lateral direction X in a direction separated from the first center line CL1 along the longitudinal direction Y. The fifth portion 215 is located at a position farther from the first portion 211 than the first turning axis A1 in the lateral direction X, and a part of the fifth portion 215 overlaps with the first portion 211 when viewed from the first turning axis A1 along the lateral direction X. The fifth portion 215 and the first portion 211 are insulated from each other.

The sixth portion 216 extends from an end portion, which is farther from the fourth portion 214, among both ends of the fifth portion 215 in the longitudinal direction Y, in a direction approaching the third portion 213 along the lateral direction X. The sixth portion 216 is located at a position farther from the first turning axis A1 than the second portion 212 in the longitudinal direction Y, and a part of the sixth portion 216 overlaps with the second portion 212 when viewed from the first turning axis A1 along the longitudinal direction Y. The sixth portion 216 and the second portion 212 are insulated from each other.

The seventh portion 217 extends from an end portion, which is farther from the fifth portion 215, among both ends of the sixth portion 216 in the lateral direction X in a direction approaching the first center line CL1 along the longitudinal direction Y. The seventh portion 217 is located at a position farther from the first turning axis A1 than the third portion 213 in the lateral direction X, and a part of the seventh portion 217 overlaps with the third portion 213 when viewed from the first turning axis A1 along the lateral direction X. The seventh portion 217 and the third portion 213 are insulated from each other. The via 52 is connected to an end portion, which is closer to the first center line CL1, among both ends of the seventh portion 217 in the longitudinal direction Y. As an example, a portion of the seventh portion 217 to which the via 52 is connected forms a first input portion.

The first conductor layer 11 includes a first main body portion 111 that extends (is located) around the first turning axis A1, and a protruding portion 112 (an example of a first protruding portion) that is provided on the first main body portion 111. In the present aspect, when viewed along the first direction Z, the first main body portion 111 has substantially the same shape as the first inductor wiring 21, and the entire first main body portion 111 overlaps with the first inductor wiring 21.

As illustrated in FIG. 3, the protruding portion 112 is formed to be directed toward the first turning axis A1 from the first main body portion 111 not along a shortest route but along a route deviating from the shortest route (that is, along a detour). When viewed along the first direction Z, the protruding portion 112 does not extend in a shortest distance D1 from a connection portion 1123 with the first main body portion 111 toward an end portion of the insulating layer 71. As an example, the end portion of the insulating layer 71 is located at a boundary between the insulating layer 71 and an insulating material 201 of a first region B1. The protruding portion 112 is formed such that a dimension in a direction in which the protruding portion 112 extends is larger than the shortest distance D1. In the present aspect, the protruding portion 112 is formed to extend from the first main body portion 111 in a direction intersecting with a first virtual straight line L1, which passes through the connection portion 1123 with the first main body portion 111 and the first turning axis A1, and to be directed toward the first turning axis A1. In the present aspect, the protruding portion 112 includes a stretching portion 1121 and a curved portion 1122. When viewed along the first direction Z, the stretching portion 1121 extends from a portion of the first main body portion 111 overlapping with the first portion 211 of the first inductor wiring 21 toward the first center line CL1 along the longitudinal direction Y. The curved portion 1122 is curved from an end portion, which is closer to the first center line CL1, among both ends of the stretching portion 1121 in the longitudinal direction Y, toward the first turning axis A1. That is, the first inductor wiring 21 and the protruding portion 112 form an angle other than a right angle.

In the present aspect, an end portion, which is farther from the first main body portion 111, among both ends of the protruding portion 112 in a direction in which the protruding portion 112 extends (that is, an end portion, which is closer to the first turning axis A1, among both ends of the curved portion 1122 in a direction in which the curved portion 1122 extends) is in contact with the magnetic material 201 of the element body 2 located in the first region B1 described later. An end portion, which is closer to the first inductor wiring 21, among both ends of the protruding portion 112 in the first direction Z is in contact with an insulating layer 77 (an example of a first insulating layer). The insulating layer 77 is in contact with a first side surface 2101-, which is located closer to the first turning axis A1 in the second direction (for example, the lateral direction X), among the side surfaces of the first inductor wiring 21 intersecting with the second direction (for example, the lateral direction X). The first main body portion 111 and the protruding portion 112 may be formed of the same member or may be formed of different members. The second direction may be any direction as long as the direction intersects with the first direction, and may be, for example, a direction having components or vectors in both the lateral direction X and the longitudinal direction Y, in addition to the lateral direction X or the longitudinal direction Y.

The phrase “in contact with the magnetic material 201” means being in contact with a part of a material forming the magnetic material 201. In a case in which the magnetic material 201 is formed of, for example, a composite body of a resin and an inorganic filler (for example, a composite body of epoxy and FeSiCr), a distal end portion of the first main body portion 111 is in contact with at least one of the resin and the inorganic filler of the magnetic material 201. The resin contained in the magnetic material 201 includes, for example, epoxy, acryl, a liquid crystal polymer, phenol, and a combination thereof, and is responsible for the strength of the element body 2 and a good insulating property. The inorganic filler contained in the magnetic material 201 includes, for example, a metal magnetic powder (for example, a powder containing, as a main component, an Fe element such as an Fe, FeSi-based, FeSiCr-based, or FeNi-based powder). The magnetic material 201 in this case has a high magnetic permeability and a high magnetism saturation density. The inorganic filler does not need to be a single type of magnetic powder, and may be a magnetic powder in which different compositions and different particle diameters are combined, or may contain an insulating filler such as silica to ensure a coefficient of linear expansion and the insulating property.

As illustrated in FIG. 3, in the present aspect, the first conductor layer 11 includes three lead-out portions 151, 152, and 153.

When viewed along the first direction Z, the lead-out portion 151 extends from a portion of the first main body portion 111 overlapping with the fourth portion 214 of the first inductor wiring 21 in a direction approaching the first turning axis A1 in the second direction (for example, the longitudinal direction Y). The portion of the first main body portion 111 provided with the lead-out portion 151 is a portion of the first main body portion 111 that faces the first turning axis A1 and is farthest from the first turning axis A1 in the second direction (for example, the longitudinal direction Y).

A distal end portion, which is farther from the first main body portion 111, among both ends of the lead-out portion 151 in the longitudinal direction Y is in contact with the magnetic material 201 located in the first region B1 described later.

When viewed along the first direction Z, the lead-out portion 152 extends from a portion of the first main body portion 111 overlapping with the seventh portion 217 of the first inductor wiring 21 in a direction separated from the first turning axis A1 in the second direction (for example, the lateral direction X).

When viewed along the first direction Z, the lead-out portion 153 extends from a portion of the first main body portion 111 overlapping with the fifth portion 215 of the first inductor wiring 21 in a direction that is separated from the first turning axis A1 and that is opposite to the lead-out portion 152 in the second direction (for example, the lateral direction X).

A distal end portion, which is farther from the first main body portion 111, among both ends of the lead-out portion 152 in the lateral direction X is exposed from a side surface 204 of the element body 2. The side surface 204 faces the seventh portion 217 of the first inductor wiring 21 in the lateral direction X, and extends along the longitudinal direction Y. A distal end portion, which is farther from the first main body portion 111, among both ends of the lead-out portion 153 in the lateral direction X is exposed from a side surface 205 of the element body 2. The side surface 205 faces the fifth portion 215 of the first inductor wiring 21 in the lateral direction X, and extends along the longitudinal direction Y.

For example, “widths of the lead-out portions 151 and 152” and a “width of the first inductor wiring 21” are defined as follows. In this case, the widths of the lead-out portions 151 and 152 are larger than the width of the first inductor wiring 21. Sizes of the lead-out portions 151 and 152 in a direction intersecting with a direction in which the lead-out portions 151 and 152 extend (for example, the lateral direction X in a case of the lead-out portion 151, and in the longitudinal direction Y in a case of the lead-out portion 152) when viewed along the first direction Z are defined as the “widths of the lead-out portions 151 and 152”. A size of the first inductor wiring 21 in a direction intersecting with a direction in which the first inductor wiring 21 extends is defined as the “width of the first inductor wiring 21”.

As illustrated in FIG. 3, the element body 2 has, inside, the first region B1 closer to the first turning axis A1 than the first inductor wiring 21 and a second region B2 farther from the first turning axis A1 than the first inductor wiring 21. In the present aspect, the first region B1 is surrounded by the first portion 211 to the fifth portion 215 of the first inductor wiring 21 when viewed along the first direction Z. The magnetic material 201 and a non-magnetic material 203 are located in the first region B1. When viewed along the first direction Z, the magnetic material 201 of the first region B1 has a substantially rectangular shape and is adjacent to a portion (in the present aspect, the first portion 211 to the third portion 213) with which the first inductor wiring 21 overlaps when viewed from the first turning axis A1 along the second direction. In other words, the magnetic material 201 is adjacent to a portion including the largest number of the first inductor wirings 21 when viewed from the first turning axis A1 along the second direction. The non-magnetic material 203 of the first region B1 is provided between a portion (in the present aspect, the fourth portion 214 and the fifth portion 215) with which the first inductor wiring 21 does not overlap and the magnetic material 201 of the first region B1 when viewed from the first turning axis A1 along the second direction. The non-magnetic material 203 includes the insulating layer 77 and extends along the third portion 213, the fourth portion 214, and the fifth portion 215 when viewed along the first direction Z. The magnetic material 201 is located over the entire second region B2.

As illustrated in FIG. 4, the second inductor wiring 22 extends around the second turning axis A2 along the first direction Z. In the present aspect, the second inductor wiring 22 has a spiral shape that is wound in a direction opposite to the first inductor wiring 21 when viewed along the first direction Z. As an example, the second turning axis A2 is located at the center with respect to the outer shape of the second inductor wiring 22. The second inductor wiring 22 is formed of, for example, a multilayer body of L/S/t (=100/10/150 μm). Vias 53 and 54 extending in the first direction Z are connected to both ends of the second inductor wiring 22 in a direction in which the second inductor wiring 22 extends. As illustrated in FIG. 2, the via 53 connects the second inductor wiring 22 and a vertical wiring 61 to each other. The vertical wiring 61 connects the second inductor wiring 22 and the external terminal 101 to each other through the via 53. An insulating layer 75 is located between the second inductor wiring 22 and the vertical wiring 61 in the first direction Z. The insulating layer 75 has, for example, a thickness of 15 μm.

The second inductor wiring 22 has a first portion 221 to a seventh portion 227.

The first portion 221 extends from an end portion located close to the first turning axis A1 to which the via 53 is connected, in a direction approaching the second center line CL2 along the longitudinal direction Y. As an example, a portion of the first portion 221 to which the via 53 is connected forms a second output portion. The vias 51 and 53 are adjacent to each other when viewed along the first direction Z. The via 51 connects a portion of the first inductor wiring 21 to which the via 51 is connected and a portion of the second inductor wiring 22 to which the via 53 is connected, to each other. That is, the first output portion and the second output portion are adjacent to each other. The phrase “the first output portion and the second output portion are adjacent to each other” means, for example, a state in which the vias 51 and 53 are located in a very narrow region (for example, within 20 μm) when viewed along the first direction Z. In the present aspect, the vias 51 and 53 are located at a distance of about 10 μm when viewed along the first direction Z.

The second portion 222 extends from an end portion, which is closer to the second center line CL2, among both ends of the first portion 221 in the longitudinal direction Y, along the lateral direction X.

The third portion 223 extends from an end portion, which is farther from the first portion 221, among both ends of the second portion 222 in the lateral direction X, in a direction separated from the second center line CL2 along the longitudinal direction Y.

The fourth portion 224 extends from an end portion, which is farther from the second portion 222, among both ends of the third portion 223 in the longitudinal direction Y, in a direction approaching the first portion 221 along the lateral direction X.

The fifth portion 225 extends from an end portion, which is farther from the third portion 223, among both ends of the fourth portion 224 in the lateral direction X, in a direction approaching the second center line CL2 along the longitudinal direction Y. The fifth portion 225 is located at a position farther from the second turning axis A2 than the first portion 221 in the lateral direction X, and a part of the fifth portion 225 overlaps with the first portion 221 when viewed from the second turning axis A2 along the lateral direction X. The fifth portion 225 and the first portion 221 are insulated from each other.

The sixth portion 226 extends from an end portion, which is farther from the fourth portion 224, among both ends of the fifth portion 225 in the longitudinal direction Y, in a direction approaching the third portion 223 along the lateral direction X. The sixth portion 226 is located at a position farther from the second portion 222 than the second turning axis A2 in the longitudinal direction Y, and a part of the sixth portion 226 overlaps with the second portion 222 when viewed from the second turning axis A2 along the longitudinal direction Y. The sixth portion 226 and the second portion 222 are insulated from each other.

The seventh portion 227 extends from an end portion, which is farther from the fifth portion 225, among both ends of the sixth portion 226 in the lateral direction X, in a direction separated from the second center line CL2 along the longitudinal direction Y. The seventh portion 227 is located at a position farther from the second turning axis A2 than the third portion 223 in the lateral direction X, and a part of the seventh portion 227 overlaps with the third portion 223 when viewed from the second turning axis A2 along the lateral direction X. The seventh portion 227 and the third portion 223 are insulated from each other. The via 54 is connected to an end portion, which is farther from the second center line CL2, among both ends of the seventh portion 227 in the longitudinal direction Y. As an example, a portion of the seventh portion 227 to which the via 54 are connected forms a second input portion. As illustrated in FIGS. 3 and 4, the vias 52 and 54 are located with spacing from each other in the longitudinal direction Y when viewed along the first direction Z. That is, the first input portion and the second input portion are located at positions separated from each other in the second direction (for example, the longitudinal direction Y). Since the vias 52 and 54 are located at positions separated from each other by a distance of 200 μm or more (for example, 500 μm) when viewed along the first direction Z, the first input portion and the second input portion can be separated from each other.

As illustrated in FIG. 4, the second conductor layer 12 includes a second main body portion 121 that extends (is located) around the second turning axis A2, and a protruding portion 122 (an example of a second protruding portion) that is provided on the second main body portion 121. When viewed along the first direction Z, the second main body portion 121 has a turning portion 1211 that has substantially the same shape as the second inductor wiring 22 and a non-turning portion 1212 that is adjacent to the turning portion 1211 in an electrically independent state. In the present aspect, the entire turning portion 1211 overlaps with the second inductor wiring 22 when viewed along the first direction Z. When viewed along the first direction Z, the non-turning portion 1212 has an elongated circular shape that extends along the longitudinal direction Y and is adjacent to a portion in which the sixth portion 226 and the seventh portion 227 of the second inductor wiring 22 are connected to each other. The turning portion 1211 and the protruding portion 122 of the second main body portion 121 may be formed of the same member or may be formed of different members.

A lead-out portion 165 is provided at the center of the non-turning portion 1212 in the longitudinal direction Y. The lead-out portion 165 extends from the non-turning portion 1212 in a direction separated from the second turning axis A2 in the lateral direction X. A distal end portion, which is farther from the non-turning portion 1212, among both ends of the lead-out portion 165 in the lateral direction X is in contact with the magnetic material 201 of the element body 2. The non-turning portion 1212 and the lead-out portion 165 of the second main body portion 121 may be formed of the same member or may be formed of different members.

The protruding portion 122 is formed to be directed toward the second turning axis A2 from the second main body portion 121 not along a shortest route but along a route deviating from the shortest route (that is, along a detour). When viewed along the first direction Z, the protruding portion 122 does not extend in a shortest distance D2 from a connection portion 1223 with the second main body portion 121 toward an end portion of an insulating layer 72. As an example, the end portion of the insulating layer 72 is located at a boundary between the insulating layer 72 and the insulating material 201 of a first region C1. The protruding portion 122 is formed such that a dimension in a direction in which the protruding portion 122 extends is larger than the shortest distance D2. In the present aspect, the protruding portion 122 is formed to extend from the second main body portion 121 in a direction intersecting with a second virtual straight line L2, which passes through the connection portion 1223 with the second main body portion 121 and the second turning axis A2, and to be directed toward the second turning axis A2. In the present aspect, the protruding portion 122 includes a stretching portion 1221 and a curved portion 1222. When viewed along the first direction Z, the stretching portion 1221 extends from a portion of the second main body portion 121 overlapping with the first portion 221 of the second inductor wiring 22 in a direction separated from the second center line CL2 along the longitudinal direction Y. The curved portion 1222 is curved from an end portion, which is farther from the second center line CL2, among both ends of the stretching portion 1221 in the longitudinal direction Y, toward the second turning axis A2. That is, the second inductor wiring 22 and the protruding portion 122 form an angle other than a right angle.

As illustrated in FIG. 4, in the present aspect, an end portion, which is farther from the second main body portion 121, among both ends of the protruding portion 122 in a direction in which the protruding portion 122 extends (that is, an end portion, which is closer to the second turning axis A2, among both ends of the curved portion 1222 in a direction in which the curved portion 1222 extends) is in contact with the magnetic material 201 of the element body 2 located in the first region C1 described later. An end portion, which is closer to the second inductor wiring 22, among both ends of the protruding portion 122 in the first direction Z is in contact with an insulating layer 78. The insulating layer 78 is in contact with a second side surface 2201, which is located closer to the second turning axis A2 in the second direction (for example, the lateral direction X), among the side surfaces of the second inductor wiring 22 intersecting with the second direction (for example, the lateral direction X). The second main body portion 121 and the protruding portion 122 may be formed of the same member or may be formed of different members.

As illustrated in FIG. 4, in the present aspect, the second conductor layer 12 includes five lead-out portions 161, 162, 163, 164, and 165.

When viewed along the first direction Z, the lead-out portion 161 extends from a portion of the second main body portion 121 overlapping with the second portion 222 of the second inductor wiring 22 in a direction approaching the second turning axis A2 in the second direction (for example, the longitudinal direction Y).

When viewed along the first direction Z, the lead-out portion 162 extends from a portion of the second main body portion 121 overlapping with the third portion 223 of the second inductor wiring 22 in a direction approaching the second turning axis A2 in the second direction (for example, the lateral direction X).

A distal end portion, which is farther from the second main body portion 121, among both ends of the lead-out portion 161 in the longitudinal direction Y is in contact with the magnetic material 201 located in the first region C1 described later. A distal end portion, which is farther from the second main body portion 121, among both ends of the lead-out portion 162 in the lateral direction X is in contact with the magnetic material 201 located in the first region C1.

When viewed along the first direction Z, the lead-out portion 163 extends from a portion of the turning portion 1211 overlapping with the seventh portion 227 of the second inductor wiring 22 in a direction separated from the second turning axis A2 in the second direction (for example, the lateral direction X).

When viewed along the first direction Z, the lead-out portion 164 extends from a portion of the turning portion 1211 overlapping with the fifth portion 225 of the second inductor wiring 22 in a direction that is separated from the second turning axis A2 and that is opposite to the lead-out portion 163 in the second direction (for example, the lateral direction X).

When viewed along the first direction Z, the lead-out portion 165 extends from the non-turning portion 1212 in the same direction as the lead-out portion 163 in a direction separated from the second turning axis A2 in the second direction (for example, the lateral direction X).

Distal end portions, which are farther from the turning portion 1211, among both ends of the lead-out portions 163 and 165 in the lateral direction X are exposed from the side surface 204 of the element body 2. A distal end portion, which is farther from the turning portion 1211, among both ends of the lead-out portion 164 in the lateral direction X is exposed from the side surface 205 of the element body 2.

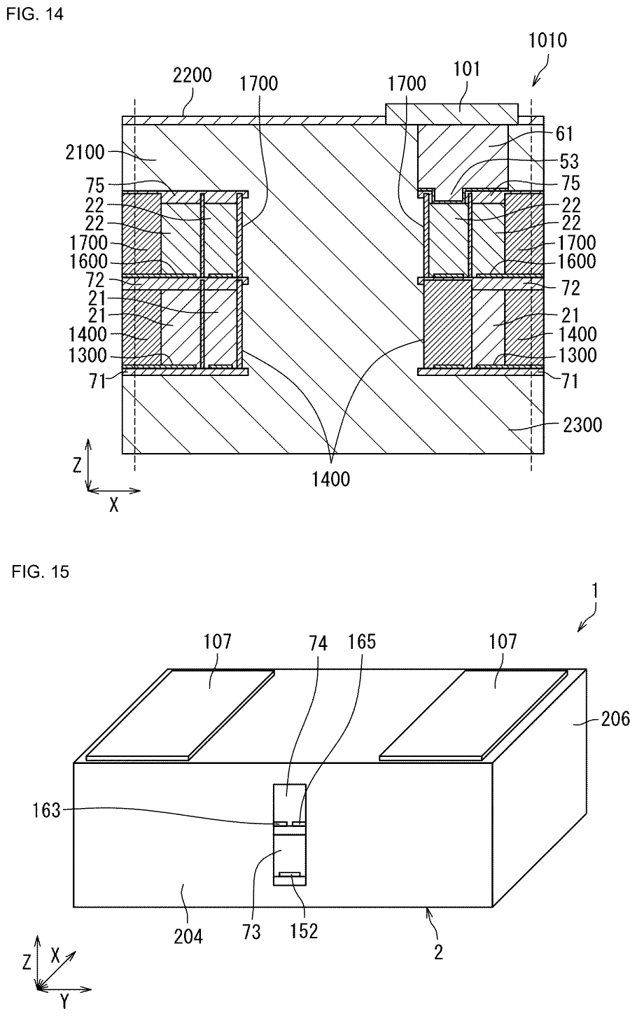

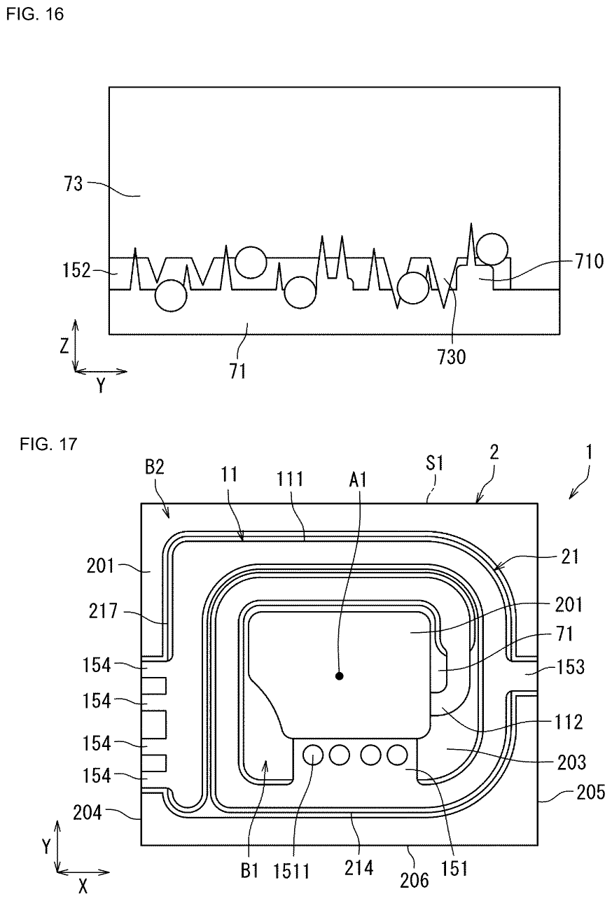

As an example, the distal end portions of the lead-out portions 152, 153, 163, 164, and 165, which are exposed from the side surfaces 204 and 205, are in contact with at least one insulating layer. For example, during the fragmentation (see FIG. 14), the side surface 204 is formed by performing a down cut or an up cut (advancing while rotating a blade along the first direction Z), so that the insulating layer (for example, the insulating layer 71 and the insulating layer 73) located around the lead-out portion 152 is stretched as illustrated in FIG. 16, and the distal end portion of the lead-out portion 152 is covered. As a result, the lead-out portion 152 of which the distal end portion is in contact with at least one insulating layer is obtained. In FIG. 16, a stretched portion of the insulating layer 71 is denoted by 710, and a stretched portion of the insulating layer 73 is denoted by 730. In the same manner, the lead-out portions 153, 163, 164, and 165 of which the distal end portion is in contact with at least one insulating layer are obtained. The distal end portion of the protruding portion 112 is covered with an insulating filler such as silica included in the first insulating layer 71 or the third insulating layer 73, so that the interlayer short-circuit resistance and the like are further improved.

As illustrated in FIG. 4, the element body 2 has, inside, the first region C1 closer to the second turning axis A2 than the second inductor wiring 22 and a second region C2 farther from the second turning axis A2 than the second inductor wiring 22. In the present aspect, the first region C1 is surrounded by the first portion 221 to the fifth portion 225 of the second inductor wiring 22 when viewed along the first direction Z. The magnetic material 201 and the non-magnetic material 203 are located in the first region C1. When viewed along the first direction Z, the magnetic material 201 of the first region C1 has a substantially rectangular shape and is adjacent to the first portion 211 to the fourth portion 224. In other words, the magnetic material 201 is adjacent to a portion including the largest number of the second inductor wirings 22 when viewed from the second turning axis A2 along the second direction. When viewed along the first direction Z, the non-magnetic material 203 of the first region C1 includes an insulating layer 78 and is adjacent to the magnetic material 201 of the first region C1, the first portion 221, the fourth portion 224, and the fifth portion 225. The magnetic material 201 is located over the entire second region C2.

As illustrated in FIG. 4, the inductor component 1 includes a first pad portion 81 and a second pad portion 82 that are located on the second virtual plane S2. The first pad portion 81 is located to overlap with the non-turning portion 1212 of the second conductor layer 12 when viewed along the first direction Z. A via 55 is connected to an end portion, which is closer to the second center line CL2, among both ends of the first pad portion 81 in the longitudinal direction Y. The first pad portion 81 and the second pad portion 82 are located symmetrically with respect to each other with the second center line CL2 interposed therebetween, and have a shape symmetrical with respect to each other with the second center line CL2 interposed therebetween.

As illustrated in FIG. 2, the inductor component 1 includes the insulating layer 71 (an example of a first interlayer insulating layer) and the insulating layer 72 (an example of a second interlayer insulating layer) located inside the element body 2. The insulating layer 71 is in contact with the first conductor layer 11 and is located on a side opposite to the first inductor wiring 21 in the first direction Z. The insulating layer 72 is in contact with the second conductor layer 12 and is located on a side opposite to the second inductor wiring 22 in the first direction Z.

As an example, the first conductor layer 11 has a thickness that is a dimension in the first direction Z of smaller than 1.0 μm. The thickness of the first conductor layer 11 is smaller than 1/100 of the thickness of the first inductor wiring 21. The second conductor layer 12 may also be formed in the same manner as the first conductor layer 11. That is, the second conductor layer 12 may be formed to have a thickness of smaller than 1.0 μm and smaller than 1/100 of the thickness of the second inductor wiring 22.

As an example, the first conductor layer 11 and the second conductor layer 12 each include a single layer (Cu or Ag) or a plurality of layers (for example, Ti/Cu) laminated along the first direction Z. With this configuration, the degree of freedom in the design of the inductor component 1 can be increased, so that the cost reduction can be achieved without impairing a quality of the inductor component 1. For example, the number of layers forming each conductor layer can be optionally set depending on each layer. For example, by forming the first conductor layer 11 such that two layers (Ti/Cu) are included and the second conductor layer 12 such that two layers (Cu) are included, the close-contact strength of the first conductor layer 11 to the resin can be improved, and the close-contact strength of the second conductor layer 12 to copper (sacrificial copper) can be increased.

In the present aspect, as illustrated in FIG. 2, the inductor component 1 includes the insulating layer 73 (an example of a second insulating layer) and an insulating layer 74 (an example of a third insulating layer) located inside the element body 2. The insulating layer 73 is in contact with end portions, which are closer to the first inductor wiring 21, among both ends of the lead-out portions 152 and 153 (an example of a first lead-out portion) of the first conductor layer 11 in the first direction Z. As an example, the insulating layer 73 extends from the first virtual plane S1 toward the second virtual plane S2 along the first direction Z. The insulating layer 73 is formed to have a dimension (=thickness) in the first direction Z larger than the dimension of the first inductor wiring 21. As a result, the insulation between a first layer including the first conductor layer 11 and the first inductor wiring 21 and a second layer including the second conductor layer 12 and the second inductor wiring 22 can be reliably ensured. The insulating layer 74 is in contact with end portions, which are closer to the second inductor wiring 22, among both ends of the lead-out portions 163, 164, and 165 (an example of a second lead-out portion) of the second conductor layer 12 in the first direction Z. As an example, the insulating layer 74 extends from the second virtual plane S2 toward the main surface 202 along the first direction Z. The insulating layer 74 is formed to have a thickness larger than the thickness of the second inductor wiring 22.

As an example, as illustrated in FIGS. 3 and 4, the lead-out portion 152 of the first conductor layer 11 and the lead-out portions 163 and 165 of the second conductor layer 12 are located at positions overlapping with each other in the first direction Z, and the lead-out portion 153 of the first conductor layer 11 and the lead-out portion 164 of the second conductor layer 12 are located at positions overlapping with each other in the first direction Z. When viewed along the first direction Z, the size of the insulating layer 74 is the same size as the size of the insulating layer 73 or is smaller than the size of the insulating layer 73, and the insulating layer 73 overlaps with the entire insulating layer 74.

In the present aspect, as illustrated in FIG. 2, the inductor component 1 includes the external terminal 101 that is provided on the main surface 202 and the vertical wiring 61 that is located inside the element body 2. The vertical wiring 61 extends in the first direction Z and connects the second inductor wiring 22 and the external terminal 101 to each other in a state of being in contact with the magnetic material 201 of the element body 2 in the second direction. In the present aspect, the vertical wiring 61 is provided at a position not overlapping with the first regions B1 and C1 and the second regions B2 and C2 when viewed along the first direction Z.

In the present aspect, as illustrated in FIG. 3, the first conductor layer 11 and the third conductor layer 13 are located with spacing from each other in the second direction (for example, the longitudinal direction Y). The lead-out portions 152 and 153 of the first conductor layer 11 are provided in a portion other than a portion of the first main body portion 111 facing the third conductor layer 13 (that is, a portion of the first main body portion 111 facing the side surfaces 204 and 205 of the element body 2). The lead-out portions 152 and 153 (an example of a third lead-out portion) of the third conductor layer 13 are provided in a portion other than a portion of the third main body portion 131 facing the first conductor layer 11 (that is, a portion of the third main body portion 131 facing the side surfaces 204 and 205 of the element body 2).

The insulating layer (for example, the insulating layers 71, 72, and 75) in contact with both ends of the first inductor wiring 21 and the second inductor wiring 22 in the first direction Z and the insulating layer (for example, the insulating layers 73, 74, 77, and 78) in contact with both ends of the first inductor wiring 21 and the second inductor wiring 22 in the second direction are formed of, for example, different materials. As an example, the insulating layers 71, 72, and 75 are formed of an insulating material consisting of an epoxy material and an inorganic filler, and the insulating layers 73, 74, 77, and 78 are formed of an acrylic insulating material.

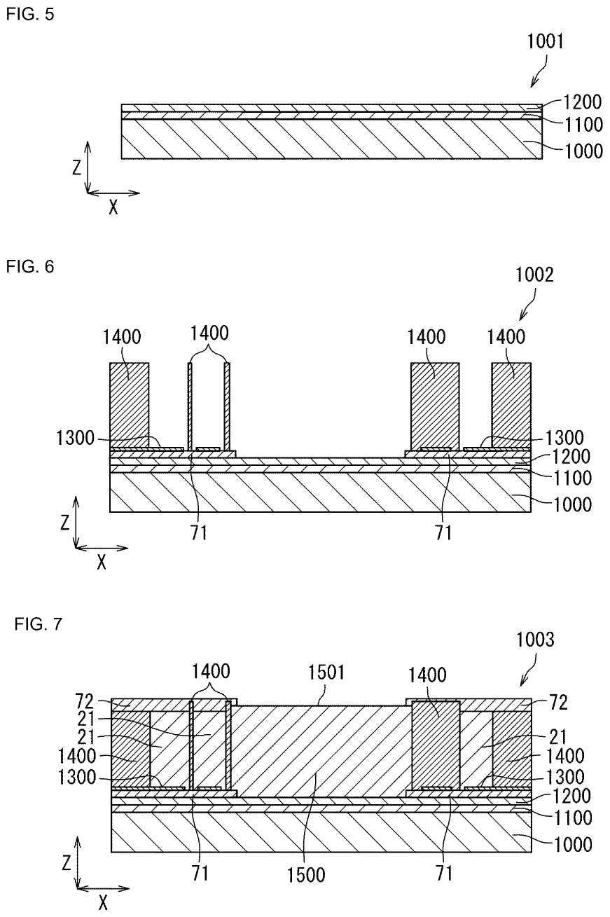

An example of a manufacturing method for the inductor component 1 will be described with reference to FIGS. 5 to 14. In the following description, the third conductor layer 13, the fourth conductor layer 14, the third inductor wiring 23, and the fourth inductor wiring 24 will not be described. FIGS. 5 to 14 are views corresponding to cross sections taken along a line II-II of FIG. 1. In the manufacturing method illustrated in FIGS. 5 to 14, for example, a part or all of the steps are automatically performed by using a manufacturing apparatus for the inductor component 1.

As illustrated in FIGS. 5 and 6, the manufacturing apparatus forms the insulating layer 71 on a first multilayer body 1001 in which an adhesive layer 1100 and a seed layer (conductor) 1200 are laminated on a substrate 1000, and then forms a pattern seed 1300 extending over the insulating layer 71 and the seed layer 1200 and a permanent resist 1400 to form a second multilayer body 1002. The pattern seed 1300 forms the first conductor layer 11. The insulating layer 71 is formed by, for example, a step including lamination of insulating layers, photolithography (photolithography), and solidification. The pattern seed 1300 is formed by, for example, a step including sputtering (seed formation), resist lamination, photolithography, seed etching, and resist peeling. The permanent resist 1400 is formed by, for example, a step including permanent resist coating, photolithography, and solidification. A part of the permanent resist 1400 forms the non-magnetic material 203 and the insulating layer 73.

As illustrated in FIG. 7, the manufacturing apparatus simultaneously forms the first inductor wiring 21 and sacrificial copper 1500 on the second multilayer body 1002, and then forms the insulating layer 72 on the first inductor wiring 21. The first inductor wiring 21 and the sacrificial copper 1500 are formed by, for example, a step including electric field plating (for example, electric field copper plating). The insulating layer 72 is formed by, for example, a step including insulating layer lamination, photolithography, and solidification. In this case, a magnetic path cavity 1501 and the vias 51 and 52 are simultaneously formed during the photolithography step.

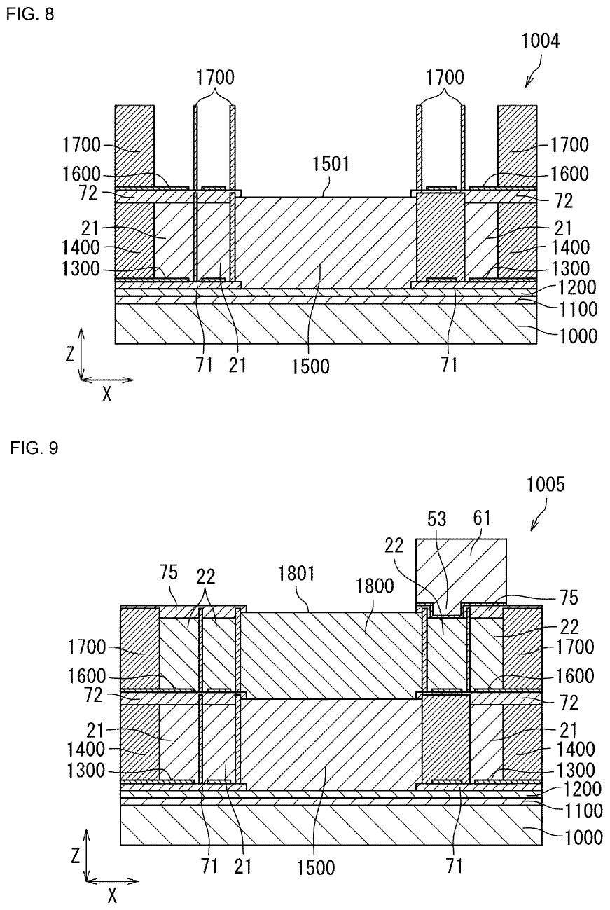

As illustrated in FIG. 8, the manufacturing apparatus forms a pattern seed 1600 and a permanent resist 1700 located on the insulating layer 72 on a third multilayer body 1003 to form a fourth multilayer body 1004. The pattern seed 1600 forms the second conductor layer 12. The pattern seed 1600 is formed by, for example, a step including sputtering (seed formation), resist lamination, photolithography, seed etching, and resist peeling. The permanent resist 1700 is formed by a step including permanent resist lamination, photolithography, and solidification. A part of the permanent resist 1700 forms the insulating layer 74.

The pattern seed 1600 may be formed of the same material as the pattern seed 1300 of the second multilayer body 1002, or may be formed of a material different from the pattern seed 1300. The pattern seeds 1300 and 1600 are formed by selecting the optimal material in each layer. For example, by forming the pattern seed 1300 of the first layer with a conductive material containing Ti, the close-contact strength to the insulating layer 71 and the seed layer 1200 can be improved. By forming the pattern seed 1600 of the second layer with the same conductive material (for example, only Cu) as the second inductor wiring 22, the connectivity with the vias 53 and 54 can be improved.

As illustrated in FIG. 9, the manufacturing apparatus forms the second inductor wiring 22 and sacrificial copper 1800 on the fourth multilayer body 1004 together, forms the insulating layer 75 on the second inductor wiring 22, and then forms the vertical wiring 61 on the insulating layer 75 to form a fifth multilayer body 1005. The second inductor wiring 22 and the sacrificial copper 1800 are formed by, for example, a step including electric field plating (for example, electric field copper plating). The insulating layer 75 is formed by a step including insulating layer lamination, photolithography, and solidification. In this case, a magnetic path cavity 1801 and the vias 53 and 54 are simultaneously formed during the photolithography step. The vertical wiring 61 is formed by, for example, a step of sputtering (seed formation on the entire surface), laminating a resist, photolithography, electrolytic plating, resist peeling, and seed etching.

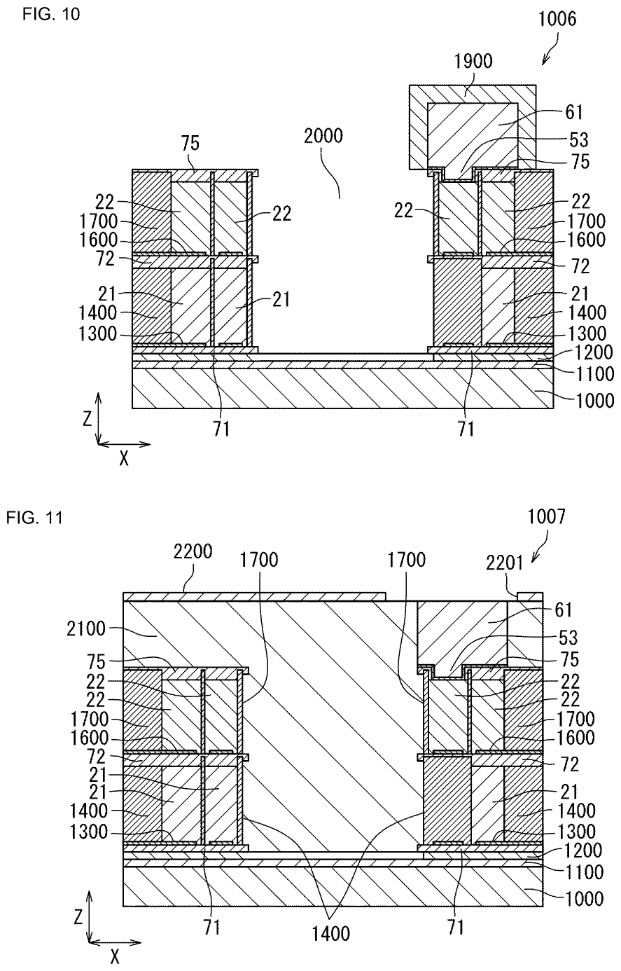

As illustrated in FIG. 10, the manufacturing apparatus forms a protective layer 1900 on the vertical wiring 61 on the fifth multilayer body 1005, removes the sacrificial copper 1500 and 1800 to form a magnetic path hole 2000, and then forms a sixth multilayer body 1006. The protective layer 1900 is formed by, for example, a step including resist lamination and photolithography. The removal of the sacrificial copper 1500 and 1800 is performed by, for example, etching. In a case in which the pattern seed 1300 of the first layer contains Ti, after Cu etching, Ti etching is performed, and a part of the seed layer 1200 remains.

As illustrated in FIG. 11, the manufacturing apparatus removes the protective layer 1900 of the sixth multilayer body 1006, forms a magnetic layer 2100, and then forms a solder resist (insulating layer) 2200 on the magnetic layer 2100 to form a seventh multilayer body 1007. The protective layer 1900 is removed by, for example, a step including resist peeling. The magnetic layer 2100 is formed by, for example, a step including magnetic material pressing, solidification, and grinding. The vertical wiring 61 is exposed to the outside by grinding. The magnetic layer 2100 forms a part of the magnetic material 201. The solder resist 2200 is formed by, for example, a step including solder resist lamination, photolithography, and solidification. A cavity 2201 through which the vertical wiring 61 is exposed to the outside is formed in the solder resist 2200. The solder resist 2200 forms the insulating layer 76.

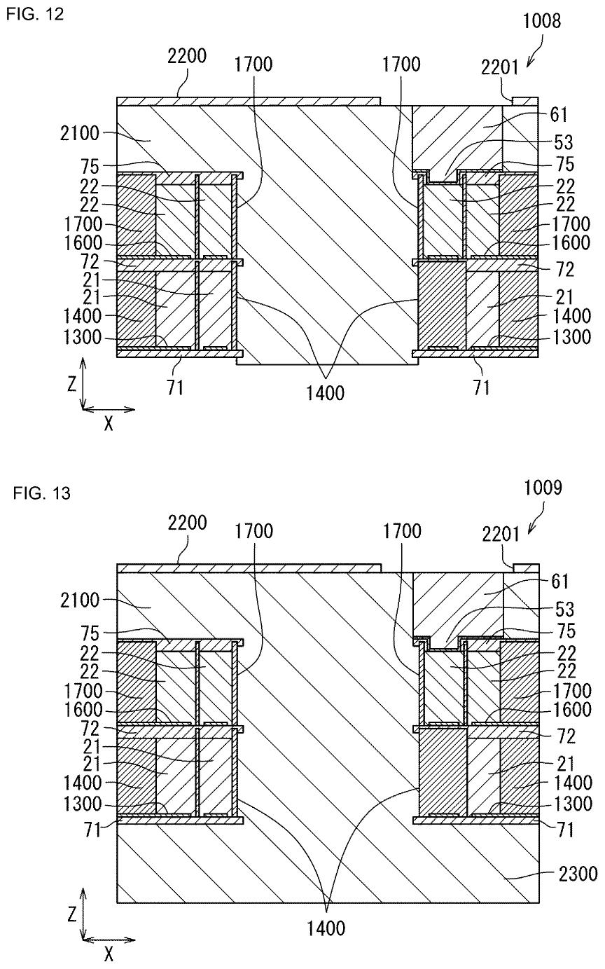

As illustrated in FIG. 12, the manufacturing apparatus removes the substrate 1000, the adhesive layer 1100, and the seed layer 1200 from the seventh multilayer body 1007 to form an eighth multilayer body 1008. The substrate 1000 and the adhesive layer 1100 are removed by, for example, mechanically peeling the adhesive layer 1100. The seed layer 1200 is removed by, for example, wet etching or polishing. In a case in which the seed layer 1200 is removed by wet etching, a part of the metal magnetic powder of the magnetic layer 2100 is etched, and a surface thereof is roughened, so that the close-contact strength with a magnetic layer 2300 formed in the next step is improved.

As illustrated in FIG. 13, the manufacturing apparatus forms the magnetic layer 2300 on the eighth multilayer body 1008 to form a ninth multilayer body 1009. The magnetic layer 2300 is formed by, for example, a step including magnetic material pressing, solidification, and grinding. Grinding is performed to adjust the thickness of the element body 2. The thickness of the element body 2 may be adjusted by adjusting an amount of pressing during the formation of the magnetic layer 2300 without performing grinding. The magnetic layer 2300 forms a part of the magnetic material 201.

As illustrated in FIG. 14, the manufacturing apparatus forms the external terminal 101 on the ninth multilayer body 1009, forms a tenth multilayer body 1010, and then fragments the tenth multilayer body 1010 to form the inductor component 1 illustrated in FIG. 2. The external terminal 101 is formed by, for example, a step including sputtering (Cu seed), resist lamination, photolithography, electrolytic plating, resist peeling, and seed etching. The fragmentation is performed, for example, along a broken line illustrated in FIG. 14.

The exposed vertical wiring 61 may be used as the external terminal instead of forming the external terminal 101. As in the present aspect, in a case in which the configuration is adopted in which the external terminal 101 is formed in the cavity 2201 of the solder resist 2200 and is connected to the vertical wiring 61, an area of the external terminal 101 can be increased, and thus the fixation force of the inductor component 1 to another device or the like can be improved. In addition, since the external terminal 101 having any shape such as a protruding shape can be formed, the degree of freedom in a case of mounting the inductor component 1 is improved.

The external terminal 101 may be formed without forming the solder resist 2200. The external terminals 101 may be formed, for example, like the vertical wiring 61, by forming the seed layer on the entire surface and then performing electrolytic plating. In this case, the external terminal 101 has a configuration similar to a Cu bump.

The inductor component 1 can exhibit the effects described below.

The inductor component 1 includes the first conductor layer 11, the first inductor wiring 21, and the insulating layer 71 (an example of a first interlayer insulating layer). The first conductor layer 11 is located on the first virtual plane S1. The first inductor wiring 21 is provided on the first conductor layer 11 and extends around the first turning axis A1. The insulating layer 71 is in contact with the first conductor layer 11 and is located on a side opposite to the first inductor wiring 21 with respect to the first conductor layer 11 in the first direction Z. The first conductor layer 11 includes the first main body portion 111 that extends around the first turning axis A1, and the protruding portion 112 (an example of a first protruding portion) that extends from the first main body portion 111 in a direction approaching the first turning axis A1. The protruding portion 112 does not extend in the shortest distance from the connection portion 1123 with the first main body portion 111 toward the end portion of the insulating layer 71 when viewed along the first direction Z. That is, since the protruding portion 112 is directed toward the first turning axis A1 along a detour instead of the shortest route, for example, it is possible to prevent the first inductor wiring 21 from being eroded by an etching solution in a case of forming the magnetic path hole. As a result, the variation and the increase in the direct current resistance of the inductor component 1 can be suppressed. In addition, since the protruding portion 112 is provided, the power can be supplied through the insulating layer, and thus the first inductor wiring 21 can be formed by plating growth. In the plating growth (for example, an electrolytic plating method), since the first conductor layer 11 having a very high purity can be formed, the first inductor wiring 21 having high conductivity can be formed. As a result, the direct current electrical resistance of the inductor component 1 can be decreased.

The inductor component 1 includes the element body 2 that includes the magnetic material 201 and in which the first conductor layer 11 and the first inductor wiring 21 are located. The element body 2 has, inside, the first region B1 closer to the first turning axis A1 than the first inductor wiring 21 and the second region B2 farther from the first turning axis A1 than the first inductor wiring 21. The magnetic material 201 is located in the first region B1 and the second region B2. With this configuration, the acquisition efficiency of the inductance of the inductor component 1 can be improved.

The inductor component 1 includes the insulating layer 77 (an example of a first insulating layer). The insulating layer 77 is located inside the element body 2 and is in contact with the side surface of the first inductor wiring 21 intersecting with the second direction. The end portion, which is closer to the first inductor wiring 21, among both ends of the protruding portion 112 in the first direction Z is in contact with the insulating layer 77. The end, which is farther from the first main body portion 111, among both ends of the protruding portion 112 in a direction in which the protruding portion 112 extends is in contact with the magnetic material 201. With this configuration, the protruding portion 112 is protected by the insulating layer 77, and the first inductor wiring 21 is not etched during the formation of the magnetic path, so that the decrease in the direct current resistance of the inductor component 1 due to erosion can be suppressed. The acquisition efficiency of the inductance of the inductor component 1 can be improved by filling the formed magnetic path with the magnetic material 201.

The first conductor layer 11 has a thickness of smaller than 1.0 μm. The thickness of the first conductor layer 11 is smaller than 1/100 of the thickness of the first inductor wiring 21. With this configuration, the first conductor layer 11 is also sufficiently thin with respect to the first inductor wiring 21, and thus the resistance of the first inductor wiring 21 is dominant instead of the resistance of the first conductor layer 11. As a result, the selectivity of the metal material forming the first conductor layer 11 is improved. In addition, since the thickness of the first conductor layer 11 itself is sufficiently small, the interlayer short-circuit through the first conductor layer 11 can be suppressed. For example, in a case in which the first conductor layer 11 is Ti/Cu that is vapor-deposited by sputtering, Ti is formed to have a thickness of 30 nm, and Cu is formed to have a thickness of 800 nm. The first conductor layer 11 can be formed by an electroless plating method, a printing method, and the like, in addition to sputtering. For example, Au, Ag, or Al can be used as a material for the first conductor layer 11.

The inductor component 1 includes the second conductor layer 12, the second inductor wiring 22, and the insulating layer 72 (an example of a second interlayer insulating layer). The second conductor layer 12 is provided on the second virtual plane S2 parallel and adjacent to the first virtual plane S1. The second inductor wiring 22 is provided on the second conductor layer 12, is located between the first conductor layer 11 and the second conductor layer 12, and extends around the second turning axis A2. The insulating layer 72 is in contact with the second conductor layer 12 and is located on a side opposite to the second inductor wiring 22 with respect to the second conductor layer 12 in the first direction Z. The second conductor layer 12 includes the second main body portion 121 that extends around the second turning axis A2, and the protruding portion 122 (an example of a second protruding portion) that extends from the second main body portion 121 in a direction approaching the second turning axis A2. The protruding portion 122 does not extend in the shortest distance from the connection portion 1223 with the second main body portion 121 toward the end portion of the insulating layer 71 when viewed along the first direction Z. The first inductor wiring 21 includes the first input portion that is connected to the first input element and the first output portion that is connected to the output element. The second inductor wiring 22 includes the second input portion that is connected to the second input element different from the first input element and the second output portion that is connected to the output element. When viewed along the first direction Z, the first input portion and the second input portion are located at positions separated from each other in the second direction, and the first output portion and the second output portion are adjacent to each other. Since the input portions are separated and the output portions are shared, a multi-phase DCDC converter can be used. In addition, the output portions can be shared. In this case, the first inductor wiring 21 and the second inductor wiring 22 have the same potential, and the resistance of the inductor component 1 to static electricity can be increased.

The first conductor layer 11 includes the lead-out portions 151 and 152. The lead-out portions 151 and 152 extend in a direction separated from the first main body portion 111 in a direction separated from the first turning axis A1 in the second direction or in a direction approaching the first turning axis A1 in the second direction. The widths of the lead-out portions 151 and 152 are larger than the width of the first inductor wiring 21 when viewed along the first direction Z. With this configuration, the resistance of the first conductor layer 11 can be decreased. In addition, since the path in a case of supplying the power to the first inductor wiring 21 is thick and difficult to cut, stable plating growth of the first inductor wiring 21 can be achieved. As a result, the variation in the first inductor wiring 21 can be suppressed.

The inductor component 1 includes the external terminal 101 that is provided on the outer surface of the element body 2 intersecting with the first direction Z and the vertical wiring 61 that is located inside the element body 2. When viewed along the first direction Z, the vertical wiring 61 is provided at a position not overlapping with the first region B1 and the second region B2 and is in contact with the magnetic material 201 of the element body 2 in the second direction. The vertical wiring 61 extends in the first direction Z and connects the first inductor wiring 21 and the external terminal 101 to each other. Since an unnecessary force is not applied to the vertical wiring 61 in a case of filling with the magnetic material 201, the disconnection of the vertical wiring 61 can be suppressed. In addition, by forming the vertical wiring 61 to be in contact with the magnetic material 201 in the second direction, the volume of the magnetic material 201 can be increased, and the acquisition efficiency of the inductance of the inductor component 1 can be improved. Since the vertical wiring 61 is a wiring for connection to the external terminal 101, the insulating property can be ensured even without the insulating layer. Therefore, since the step of forming the insulating layer on the vertical wiring 61 is not necessary, the manufacturing cost of the inductor component 1 can be reduced. The vertical wiring 61 is not limited to being connected to the second inductor wiring 22 through the via 53, and may be directly connected to the second inductor wiring 22. In addition, the vertical wiring 61 may be connected to the second inductor wiring 22 through the seed layer or a layer necessary for forming the vertical wiring 61, in addition to the via 53.

The first conductor layer 11 includes the lead-out portion 151 that extends from the first main body portion 111 in a direction approaching the first turning axis A1 in the second direction. The lead-out portion 151 is provided in a portion of the first main body portion 111 that faces the first turning axis A1 in the second direction and that is farthest from the first turning axis A1. With this configuration, in a case of forming the magnetic path around the first turning axis A1, the dissolution of the first inductor wiring 21 due to etching can be suppressed. As a result, it is possible to prevent the increase in the direct current resistance of the inductor component 1.

The inductor component 1 includes the second conductor layer 12, the second inductor wiring 22, and the insulating layer 72 (an example of a second interlayer insulating layer). The second conductor layer 12 is provided on the second virtual plane S2 parallel and adjacent to the first virtual plane S1. The second inductor wiring 22 is provided on the second conductor layer 12, is located between the first conductor layer 11 and the second conductor layer 12, and extends around the second turning axis A2. The insulating layer 72 is in contact with the second conductor layer 12 and is located on a side opposite to the second inductor wiring 22 with respect to the second conductor layer 12 in the first direction Z. The second conductor layer 12 includes the second main body portion 121 that extends around the second turning axis A2, and the protruding portion 122 (an example of a second protruding portion) that extends from the second main body portion 121 in a direction approaching the second turning axis A2. The protruding portion 122 does not extend in the shortest distance from the connection portion 1223 with the second main body portion 121 toward the end portion of the insulating layer 71 when viewed along the first direction Z. The first conductor layer 11 includes the lead-out portions 152 and 153 (an example of a first lead-out portion) that extend from the first main body portion 111 in a direction separated from the first turning axis A1 along the second direction. The second conductor layer 12 includes the lead-out portions 163, 164, and 165 (an example of a second lead-out portion) that extend from the second main body portion 121 in a direction separated from the second turning axis A2 along the second direction. The inductor component 1 includes the insulating layer 73 (an example of a second insulating layer) that is in contact with the end portions, which are closer to the first inductor wiring 21, among both ends of the lead-out portions 152 and 153 in the first direction Z, and the insulating layer 74 (an example of a third insulating layer) that is in contact with the end portions, which are closer to the second inductor wiring 22, among both ends of the lead-out portions 163, 164, and 165 in the first direction Z. When viewed along the first direction Z, the lead-out portions 152 and 153 and the lead-out portions 163, 164, and 165 are located at positions overlapping with each other, the size of the insulating layer 74 is the same as or smaller than the size of the insulating layer 73, and the insulating layer 73 overlaps with the entire insulating layer 74. In a case in which the insulating layer 74 is larger than the insulating layer 73 in a case of forming the magnetic material 201 in the second regions B2 and C2, a region (void) in which the magnetic material 201 cannot be formed may be generated. In this case, there is a concern that the acquisition efficiency of the inductance of the inductor component 1 and the strength of the element body 2 may be decreased. With this configuration, in the inductor component 1, the decrease in the acquisition efficiency of the inductance of the inductor component 1 and the decrease in the strength of the element body 2 can be prevented.

The distal end portions, which are farther from the first main body portion 111, among both ends of the lead-out portions 152 and 153 of the first conductor layer 11 in the second direction are exposed from the side surfaces 204 and 205 of the element body 2 and are in contact with at least one insulating layer. With this configuration, the portion of the element body 2 exposed to the outside in the lead-out portions 152 and 153 can be covered with the insulating layer, so that the metal corrosion of the lead-out portions 152 and 153 can be prevented. For example, by forming the inductor component 1 such that the distal end portions of the lead-out portions 152 and 153 are in contact with a plurality of insulating layers, the coverage of the distal end portions of the lead-out portions 152 and 153 can be increased.

The first inductor wiring 21 and the protruding portion 112 form an angle other than a right angle when viewed along the first direction Z. With this configuration, the protruding portion 112 can be reliably directed toward the first turning axis A1 along a detour, so that the variation and the increase in the direct current resistance of the inductor component 1 can be more reliably suppressed.

The lead-out portions 152 and 153 (an example of a first lead-out portion) of the first conductor layer 11 are provided in a portion other than a portion of the first main body portion 111 facing the third conductor layer 13. The lead-out portions 152 and 153 (an example of a third lead-out portion) of the third conductor layer are provided in a portion other than a portion of the third main body portion 131 facing the first conductor layer 11. With this configuration, the insulating property between the first inductor wiring 21 and the third inductor wiring 23 can be ensured. In addition, a mounting area in a case in which a plurality of inductor wirings are mounted along the same plane can be reduced.

The inductor component 1 can be formed as follows.

As illustrated in FIG. 15, the second inductor wiring 22, among all the inductor wirings including the first inductor wiring 21 and the second inductor wiring 22, is located closest to the external terminal 107 in the first direction Z. In a case in which the distal end portions of the lead-out portions 163, 164, and 165 of the second conductor layer 12 located closest to the external terminal 107 are exposed from the element body 2, there is a possibility of solder short-circuit. By forming the inductor component 1 such that the distal end portions of the lead-out portions 163, 164, and 165 are exposed only from the side surface 204 extending in the longitudinal direction Y among a plurality of side surfaces of the element body 2, the risk of solder short-circuit can be reduced. By exposing the distal end portion of the protruding portion 122 from the center of the side surface 204 in the longitudinal direction Y, the risk of solder short-circuit can be more reliably reduced. In the inductor component 1 illustrated in FIG. 15, the distal end portion of the lead-out portion 152 of the first inductor wiring 21 is also exposed from the side surface 204 of the element body 2, but the inductor component 1 may be formed such that, for example, the distal end portion of the lead-out portion 152 is exposed from the side surface 206 of the element body 2 extending in the lateral direction X. FIG. 16 illustrates an example of the distal end portion of the lead-out portion 152 exposed from the side surface 204. The distal end portion of the lead-out portion 152 is in contact with the plurality of insulating layers 71 and 73.

As illustrated in FIG. 17, the lead-out portion 151 may be formed to include at least one cavity 1511. In the inductor component 1 illustrated in FIG. 17, the lead-out portion 151 includes, as an example, four substantially circular cavities 1511. Since the lead-out portion 151 has the cavity 1511, a route through which the etching solution enters the first inductor wiring 21 is narrowed, and it is difficult for the etching solution during the formation of the magnetic path to reach the first inductor wiring 21. As a result, the increase and the variation in direct current resistance of the first inductor wiring 21 are suppressed, and the acquisition efficiency of the inductance of the inductor component 1 can be improved.

The cavity 1511 may penetrate the lead-out portion 151 in the first direction Z or need not penetrate the lead-out portion 151 in the first direction Z. In a case in which the cavity 1511 does not penetrate the lead-out portion 151 (for example, in a case in which the cavity 1511 has a recessed shape), an area in which the first conductor layer 11 is in close contact with a base (the insulating layer 71) is increased, and thus the close-contact strength of the first conductor layer 11 to the base can be ensured. In addition, since a thin portion of the first conductor layer 11 (that is, a portion in which the cavity 1511 of the lead-out portion 151 is provided) is immediately disconnected in a case in which the etching solution erodes the thin portion, the entering of the etching solution into the first inductor wiring 21 can be suppressed. As a result, the increase and the variation in the direct current resistance of the first inductor wiring 21 can be suppressed. In a case in which the cavity 1511 penetrates the lead-out portion 151 (that is, in a case in which the cavity 1511 is a through-hole), the cavity 1511 can completely block the erosion of the etching solution, and thus the entering of the etching solution into the first inductor wiring 21 can be suppressed. As a result, the increase and the variation in the direct current resistance of the first inductor wiring 21 can be suppressed.

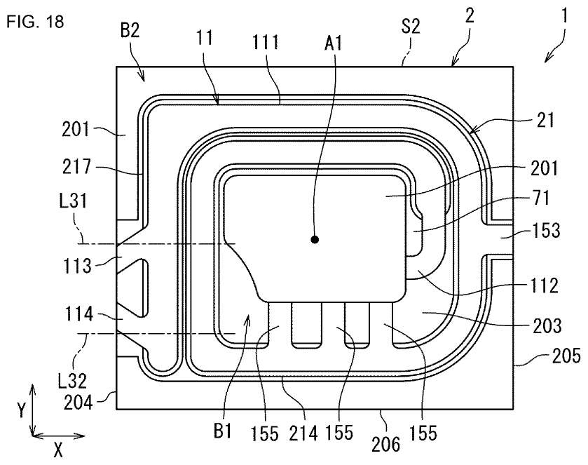

As illustrated in FIGS. 17 and 18, the first conductor layer 11 may include a plurality of lead-out portions provided in a portion of the element body 2 extending parallel to the side surfaces 204 and 206. By forming the inductor component 1 in this way, the change in the direct current resistance of the inductor component 1 can be suppressed. In the inductor component 1 illustrated in FIG. 17, the first conductor layer 11 includes four lead-out portions 154 that extend from a portion of the first main body portion 111 overlapping with the seventh portion 217 of the first inductor wiring 21 in a direction separated from the first turning axis A1 in the second direction (for example, the X direction) when viewed along the first direction Z. The four lead-out portions 154 are located with spacing from each other along the Y direction. The distal end portion, which is farther from the first main body portion 111, among both ends of each lead-out portion 154 in the X direction is exposed from the side surface 204 of the element body 2. In the inductor component 1 illustrated in FIG. 18, the first conductor layer 11 includes three lead-out portions 155 that extend from a portion of the first main body portion 111 overlapping with the fourth portion 214 of the first inductor wiring 21 in a direction approaching the first turning axis A1 in the second direction (for example, the Y direction) when viewed along the first direction Z. The distal end portion, which is farther from the first main body portion 111, among both ends of the lead-out portion 155 in the X direction is in contact with the magnetic material 201 of the first region B1.

As illustrated in FIG. 18, the first conductor layer 11 may include the protruding portions 113 and 114. The protruding portions 113 and 114 extend from the first main body portion 111 in a direction separated from the first turning axis A1 in a direction forming an angle with respect to third virtual straight lines L31 and L32 orthogonal to the side surface 204 of the element body 2. The protruding portions 113 and 114 are directed toward the side surface 204 from the first turning axis A1 along a detour instead of the shortest route. Therefore, for example, it is possible to prevent the first inductor wiring 21 from being eroded by the etching solution in a case of forming the magnetic path hole. As a result, the variation and the increase in the direct current resistance of the inductor component 1 can be suppressed. In addition, since the protruding portions 113 and 114 are provided, the power can be supplied through the insulating layer, and thus the first inductor wiring 21 can be formed by plating growth. In the plating growth (for example, an electrolytic plating method), since the first conductor layer 11 having a very high purity can be formed, the first inductor wiring 21 having high conductivity can be formed. As a result, the direct current electrical resistance of the inductor component 1 can be decreased. In the inductor component 1 illustrated in FIG. 18, the first conductor layer 11 includes the protruding portions 113 and 114 in addition to the protruding portion 112. For example, the inductor component 1 may be formed such that the first conductor layer 11 includes only the protruding portions 113 and 114.

The inductor component 1 may include a conductor layer that is located on each of three or more virtual planes parallel to each other, and an inductor wiring that is provided on each conductor layer. That is, the inductor component 1 may include three or more layers of inductor wirings.

The inductor component 1 may be formed such that only the first conductor layer 11 is located on the first virtual plane S1, or the inductor component 1 may be formed such that three or more conductor layers including the first conductor layer 11 and the third conductor layer 13 are located. Similarly, the inductor component 1 may be formed such that only the second conductor layer 12 is located on the second virtual plane S2, or the inductor component 1 may be formed such that three or more conductor layers including the second conductor layer 12 and the fourth conductor layer 14 are located. That is, the inductor component 1 in which the plurality of inductor wirings that are electrically independent of each other are disposed on the same virtual plane can be achieved.

The insulating layer (for example, the first insulating layer 71, the second insulating layer 72, the third insulating layer 73, and the fourth insulating layer 74), the vertical wiring 61, and the vias 51, 52, 53, 54, and 55, which are located inside the element body 2, may be omitted depending on the design of the inductor component 1 and the like.

The shape and the size of each part forming the inductor component 1 are not limited to the above-described aspect, and can be optionally set depending on the design of the inductor component 1 and the like. For example, the thickness of the first conductor layer 11 of the inductor component 1 is not limited to being smaller than 1.0 μm and smaller than 1/100 of the thickness of the first inductor wiring.

Each inductor wiring need only have a spiral shape when viewed along the first direction Z. For example, each inductor wiring may be a curve having the number of turns (turn count) equal to or larger than one, or may be a curve having the number of turns of smaller than one. Each inductor wiring may have a linear shape in a part thereof.

In the embodiments and modification examples of the present disclosure, a combination of the embodiments, a combination of the modification examples, or a combination of the embodiments and the modification examples can be made. The features included in the embodiments and modification examples of the present disclosure can also be combined.

The details of the configuration of the present disclosure may be changed, and a combination of the elements or a change in order in each embodiment can be achieved without departing from the scope and idea of the present disclosure.

What is claimed is:

1. An inductor component comprising:
a first conductor layer that is on a first virtual plane;
a first inductor wiring that is on the first conductor layer and that extends around a first turning axis along a first direction intersecting with the first virtual plane; and
a first interlayer insulating layer that is in contact with the first conductor layer and that is on a side opposite to the first inductor wiring with respect to the first conductor layer in the first direction,
wherein the first conductor layer includes
a first main body portion that extends around the first turning axis, and
a first protruding portion that extends from the first main body portion in a direction approaching the first turning axis, and
the first protruding portion does not extend in a shortest distance from a connection portion with the first main body portion toward an end portion of the first interlayer insulating layer when viewed along the first direction.

2. The inductor component according to claim 1, further comprising:
an element body that includes a magnetic material, and the first conductor layer and the first inductor wiring are in the element body,
wherein the element body has, inside, a first region closer to the first turning axis than the first inductor wiring and a second region farther from the first turning axis than the first inductor wiring, and
the magnetic material is in the first region and the second region.

3. The inductor component according to claim 2, further comprising:
a first insulating layer that is inside the element body and that is in contact with a side surface of the first inductor wiring intersecting with a second direction intersecting with the first direction,
wherein an end portion, which is closer to the first inductor wiring, among both ends of the first protruding portion in the first direction is in contact with the first insulating layer, and
an end, which is farther from the first main body portion, among both ends of the first protruding portion in a direction in which the first protruding portion extends is in contact with the magnetic material.

4. The inductor component according to claim 1, wherein
the first conductor layer has a thickness that is a dimension in the first direction of smaller than 1.0 μm, and
the thickness of the first conductor layer is smaller than 1/100 of the thickness of the first inductor wiring.

5. The inductor component according to claim 1, further comprising:
a second conductor layer that is on a second virtual plane parallel and adjacent to the first virtual plane;
a second inductor wiring that is on the second conductor layer, that is between the first conductor layer and the second conductor layer, and that extends around a second turning axis along the first direction; and
a second interlayer insulating layer that is in contact with the second conductor layer and that is on a side opposite to the second inductor wiring with respect to the second conductor layer in the first direction,
wherein the second conductor layer includes
a second main body portion that extends around the second turning axis, and
a second protruding portion that extends from the second main body portion in a direction approaching the second turning axis,
the second protruding portion does not extend in a shortest distance from a connection portion with the second main body portion toward an end portion of the second interlayer insulating layer when viewed along the first direction,
the first inductor wiring includes a first input portion that is connected to a first input element and a first output portion that is connected to an output element,
the second inductor wiring includes a second input portion that is connected to a second input element different from the first input element and a second output portion that is connected to the output element, and
when viewed along the first direction, the first input portion and the second input portion are at positions separated from each other in a second direction intersecting with the first direction, and the first output portion and the second output portion are adjacent to each other.

6. The inductor component according to claim 1, wherein
the first conductor layer includes a lead-out portion that extends from the first main body portion in a direction separated from the first turning axis in a second direction intersecting with the first direction or in a direction approaching the first turning axis in the second direction, and
in a case in which, when viewed along the first direction, a size of the lead-out portion in a direction intersecting with a direction in which the lead-out portion extends is defined as a width of the lead-out portion, and a size of the first inductor wiring in a direction intersecting with a direction in which the first inductor wiring extends is defined as a width of the first inductor wiring,
the width of the lead-out portion is larger than the width of the first inductor wiring.

7. The inductor component according to claim 2, further comprising:
an external terminal that is on an outer surface of the element body intersecting with the first direction; and
a vertical wiring that is inside the element body,
wherein when viewed along the first direction, the vertical wiring is at a position not overlapping with the first region and the second region, is in contact with the magnetic material of the element body in a second direction intersecting with the first direction, and extends in the first direction to connect the first inductor wiring and the external terminal to each other.

8. The inductor component according to claim 1, wherein
the first conductor layer includes a lead-out portion that extends from the first main body portion in a direction approaching the first turning axis in a second direction intersecting with the first direction, and
the lead-out portion is in a portion of the first main body portion that faces the first turning axis in the second direction and that is farthest from the first turning axis.

9. The inductor component according to claim 1, further comprising:
a second conductor layer that is on a second virtual plane parallel and adjacent to the first virtual plane;
a second inductor wiring that is on the second conductor layer, that is between the first conductor layer and the second conductor layer, and that extends around a second turning axis along the first direction; and
a second interlayer insulating layer that is in contact with the second conductor layer and that is on a side opposite to the second inductor wiring with respect to the second conductor layer in the first direction,
wherein the second conductor layer includes
a second main body portion that is around the second turning axis, and
a second protruding portion that extends from the second main body portion in a direction approaching the second turning axis,
the second protruding portion does not extend in a shortest distance from a connection portion with the second main body portion toward an end portion of the second interlayer insulating layer when viewed along the first direction,
the first conductor layer includes a first lead-out portion that extends from the first main body portion in a direction separated from the first turning axis along a second direction intersecting with the first direction,
the second conductor layer includes a second lead-out portion that extends from the second main body portion in a direction separated from the second turning axis along the second direction,
the inductor component includes
a second insulating layer that is in contact with an end portion, which is closer to the first inductor wiring, among both ends of the first lead-out portion in the first direction, and
a third insulating layer that is in contact with an end portion, which is closer to the second inductor wiring, among both ends of the second lead-out portion in the first direction, and
when viewed along the first direction, the first lead-out portion and the second lead-out portion are at positions overlapping with each other, a size of the third insulating layer is the same as or smaller than a size of the second insulating layer, and the second insulating layer overlaps with an entire third insulating layer.

10. The inductor component according to claim 1, further comprising:
an element body including the first conductor layer and the first inductor wiring,
wherein the element body has a side surface intersecting with a second direction intersecting with the first direction,
the first conductor layer includes a lead-out portion that extends from the first main body portion in a direction separated from the first turning axis in the second direction, and
a distal end portion, which is farther from the first main body portion, among both ends of the lead-out portion in the second direction is exposed from the side surface and is in contact with at least one insulating layer.

11. The inductor component according to claim 1, wherein
the first conductor layer includes a lead-out portion that extends from the first main body portion in a direction separated from the first turning axis in a second direction intersecting with the first direction or in a direction approaching the first turning axis in the second direction, and
the lead-out portion includes at least one cavity.

12. The inductor component according to claim 1, further comprising:
an element body including the first conductor layer and the first inductor wiring,
wherein the element body has a side surface intersecting with a second direction intersecting with the first direction,
the first conductor layer includes a plurality of lead-out portions that are in a portion of the first main body portion extending parallel to the side surface, and
each of the plurality of lead-out portions extends from the first main body portion in a direction separated from the first turning axis in the second direction or in a direction approaching the first turning axis in the second direction.

13. The inductor component according to claim 1, wherein
the first inductor wiring and the first protruding portion define an angle other than a right angle when viewed along the first direction.

14. The inductor component according to claim 1, further comprising:
a third conductor layer that is on the first virtual plane; and
a third inductor wiring that is on the third conductor layer and that extends around a third turning axis along the first direction,
wherein the first conductor layer includes a first lead-out portion that extends from the first main body portion in a direction separated from the first turning axis along a second direction intersecting with the first direction,
the third conductor layer includes
a third main body portion that is around the third turning axis, and
a third lead-out portion that extends from the third main body portion in a direction separated from the third turning axis along the second direction,
the first conductor layer and the third conductor layer are spaced from each other in the second direction intersecting with the first direction,
the first lead-out portion is in a portion of the first main body portion other than a portion facing the third conductor layer, and
the third lead-out portion is in a portion of the third main body portion other than a portion facing the first conductor layer.

15. The inductor component according to claim 2, wherein
the first conductor layer has a thickness that is a dimension in the first direction of smaller than 1.0 μm, and
the thickness of the first conductor layer is smaller than 1/100 of the thickness of the first inductor wiring.

16. The inductor component according to claim 2, further comprising:
a second conductor layer that is on a second virtual plane parallel and adjacent to the first virtual plane;
a second inductor wiring that is on the second conductor layer, that is between the first conductor layer and the second conductor layer, and that extends around a second turning axis along the first direction; and
a second interlayer insulating layer that is in contact with the second conductor layer and that is on a side opposite to the second inductor wiring with respect to the second conductor layer in the first direction,
wherein the second conductor layer includes
a second main body portion that extends around the second turning axis, and
a second protruding portion that extends from the second main body portion in a direction approaching the second turning axis,
the second protruding portion does not extend in a shortest distance from a connection portion with the second main body portion toward an end portion of the second interlayer insulating layer when viewed along the first direction,
the first inductor wiring includes a first input portion that is connected to a first input element and a first output portion that is connected to an output element,
the second inductor wiring includes a second input portion that is connected to a second input element different from the first input element and a second output portion that is connected to the output element, and
when viewed along the first direction, the first input portion and the second input portion are at positions separated from each other in a second direction intersecting with the first direction, and the first output portion and the second output portion are adjacent to each other.

17. The inductor component according to claim 2, wherein
the first conductor layer includes a lead-out portion that extends from the first main body portion in a direction separated from the first turning axis in a second direction intersecting with the first direction or in a direction approaching the first turning axis in the second direction, and
in a case in which, when viewed along the first direction, a size of the lead-out portion in a direction intersecting with a direction in which the lead-out portion extends is defined as a width of the lead-out portion, and a size of the first inductor wiring in a direction intersecting with a direction in which the first inductor wiring extends is defined as a width of the first inductor wiring,
the width of the lead-out portion is larger than the width of the first inductor wiring.

18. The inductor component according to claim 2, wherein
the first conductor layer includes a lead-out portion that extends from the first main body portion in a direction approaching the first turning axis in a second direction intersecting with the first direction, and
the lead-out portion is in a portion of the first main body portion that faces the first turning axis in the second direction and that is farthest from the first turning axis.

19. The inductor component according to claim 2, further comprising:
a second conductor layer that is on a second virtual plane parallel and adjacent to the first virtual plane;
a second inductor wiring that is on the second conductor layer, that is between the first conductor layer and the second conductor layer, and that extends around a second turning axis along the first direction; and
a second interlayer insulating layer that is in contact with the second conductor layer and that is on a side opposite to the second inductor wiring with respect to the second conductor layer in the first direction,
wherein the second conductor layer includes
a second main body portion that is around the second turning axis, and
a second protruding portion that extends from the second main body portion in a direction approaching the second turning axis,
the second protruding portion does not extend in a shortest distance from a connection portion with the second main body portion toward an end portion of the second interlayer insulating layer when viewed along the first direction,
the first conductor layer includes a first lead-out portion that extends from the first main body portion in a direction separated from the first turning axis along a second direction intersecting with the first direction,
the second conductor layer includes a second lead-out portion that extends from the second main body portion in a direction separated from the second turning axis along the second direction,
the inductor component includes
a second insulating layer that is in contact with an end portion, which is closer to the first inductor wiring, among both ends of the first lead-out portion in the first direction, and
a third insulating layer that is in contact with an end portion, which is closer to the second inductor wiring, among both ends of the second lead-out portion in the first direction, and
when viewed along the first direction, the first lead-out portion and the second lead-out portion are at positions overlapping with each other, a size of the third insulating layer is the same as or smaller than a size of the second insulating layer, and the second insulating layer overlaps with an entire third insulating layer.

20. An inductor component comprising:
a first conductor layer that is on a first virtual plane;
a first inductor wiring that is on the first conductor layer and that extends around a first turning axis along a first direction intersecting with the first virtual plane; and
an element body that includes a magnetic material, and the first conductor layer and the first inductor wiring are in the element body,
wherein the element body has a side surface intersecting with a second direction intersecting with the first direction, and
the first conductor layer includes
a first main body portion that extends around the first turning axis, and
a protruding portion that extends from the first main body portion in a direction separated from the first turning axis in a direction defining an angle with respect to a third virtual straight line orthogonal to the side surface.
